(19) United States
(12) Patent Application Publication
(10) Pub. No.: US 2026/0227050 A1
(43) Pub. Date: Aug. 6, 2026

(54) ILLUMINATION APPARATUS WITH OPTIMIZED LIGHT DISTRIBUTION

(71) Applicant: Frank SHUM, Sunnyvale, CA (US)

(72) Inventor: Frank SHUM, Sunnyvale, CA (US)

(21) Appl. No.: 19/576,003

(22) Filed: Mar. 24, 2026

Related U.S. Application Data
(60) Provisional application No. 63/749,684, filed on Jan. 26, 2025.

(51) Int. Cl. F21V 5/04; F21V 7/00; F21Y 115/10

(52) U.S. Cl. CPC F21V 5/045; F21V 7/0016; F21Y 2115/10

(57) ABSTRACT

Disclosed is an illumination apparatus including a housing, at least one light source, a refractor element, and a bottom lens. The light source emits light into a first hemisphere about an optical axis to form a first optical distribution. The refractor element surrounds the light source and defines a bottom opening, and the bottom lens is disposed across the bottom opening. The bottom lens includes a central portion having an inward protruding profile extending toward the light source. A first portion of the first optical distribution is transmitted through the bottom lens, while a second portion is reflected by the inward protruding profile to form a second optical distribution directed into a second hemisphere opposite the first hemisphere. The configuration enables controlled redistribution of emitted light, improved optical efficiency, and reduced light loss.

### TECHNICAL FIELD

The present disclosure relates to the field of illumination and optical systems. More particularly, the present disclosure relates to an illumination apparatus including optical elements that are adapted to influence the distribution of light emitted by a light source.

### BACKGROUND

The subject matter discussed in the background section should not be assumed to be prior art merely because of its mention in the background section. Similarly, a problem mentioned in the background section or associated with the subject matter of the background section should not be assumed to have been previously recognized in the prior art. The subject matter in the background section merely represents different approaches, which in and of themselves may correspond to implementations of the claimed technology.

Illumination apparatuses are widely used to provide artificial lighting in residential, commercial, industrial, and outdoor environments. The illumination apparatuses may be employed in a variety of applications, including general area lighting, task lighting, architectural lighting, roadway lighting, and other specialized lighting systems. In many implementations, an illumination apparatus is incorporated within a luminaire that includes mechanical, electrical, thermal, and optical components arranged to produce and distribute light into its surrounding environment.

A light source used in the illumination apparatus may include various types of light-emitting devices. In recent years, solid-state light sources, particularly light-emitting diodes (LEDs) are being widely used in illumination systems. The LEDs are capable of providing relatively high luminous efficacy, compact physical size, and long operational lifetimes. As a result, LED-based light sources are frequently integrated into luminaires together with electronic drivers, thermal management structures, and optical components that influence the characteristics of the emitted light.

Optical elements are commonly incorporated into the illumination apparatuses to influence the propagation of light emitted from a light source. The optical elements may include lenses, refractors, reflectors, diffusers, or other light-modifying structures formed from optically transmissive or reflective materials such as glass, polymeric materials, or composite materials. The geometry, placement, and optical properties of the optical elements influence the distribution of light within an illuminated space, including characteristics such as beam spread, angular distribution, and spatial intensity distribution.

In addition to the optical elements, the illumination apparatuses commonly include structural and supporting components that enable the light source and the optical elements to be integrated into a functional lighting assembly. These components include housings, mounting structures, and heat-dissipating elements that provide mechanical support, environmental protection, and thermal management. Such structures also maintain desired positional relationships between the light source and associated optical elements within the luminaire.

The arrangement and configuration of light sources, optical elements, and structural components in the illumination apparatuses vary widely depending on installation conditions, lighting objectives, and design constraints. Consequently, the illumination apparatuses may be implemented in numerous configurations and structural arrangements to achieve lighting performance suitable for different environments and applications.

### SUMMARY OF THE INVENTION

The summary is provided to introduce aspects and embodiments related to the present disclosure. Particularly, this section is provided to introduce a selection of concepts in a simplified format that is further described in the detailed description of the invention. This summary is not intended to identify key or essential inventive concepts of the disclosed subject matter nor is it intended for use in determining or limiting the scope of the disclosed subject matter.

According to an aspect of the present disclosure, an illumination apparatus is disclosed. The illumination apparatus includes a housing, at least one light source, a refractor element, and a bottom lens. The at least one light source is mounted on the housing and adapted to emit light into a first hemisphere centered about an optical axis forming a first optical distribution. The optical axis is oriented in a downward direction. The refractor element has a body portion surrounding the at least one light source and extends about the optical axis. The body portion defines a bottom opening. The bottom lens is disposed across at least a portion of the bottom opening to substantially enclose the bottom opening. The bottom lens includes a central portion having an inward protruding profile extending towards the at least one light source. At least a first portion of the first optical distribution is transmitted through the bottom lens into the first hemisphere. At least a second portion of the first optical distribution is reflected by the bottom lens to form a second optical distribution directed in an upward direction into a second hemisphere opposite the first hemisphere.

In some embodiments, the at least one light source comprises at least one of a light emitting diode (LED), or the LED and an optic positioned adjacent to the LED. The optic is adapted to intercept and redirect at least a portion of the emitted light forming the first optical distribution.

In some embodiments, the bottom lens includes a plurality of elongated features extending radially from the central portion of the bottom lens towards a peripheral region of the body portion of the refractor element.

In some embodiments, the plurality of elongated features is provided on an interior surface of the bottom lens. The interior surface of the bottom lens is the surface closest to and facing the at least one light source.

In some embodiments, the plurality of elongated features comprises one or more of grooves, ridges, prisms, flutes, or refractive structures adapted to redistribute the first optical distribution incident on the bottom lens.

In some embodiments, the inward protruding profile of the central portion has a protrusion height, measured along the optical axis from a baseline plane of the bottom lens, of at least 10 mm, 20 mm, 40 mm, 60 mm or 80 mm.

In some embodiments, a ratio of a maximum protrusion height to a lateral width of the bottom lens is at least 0.10, 0.20, 0.30, 0.40 or 0.50.

In some embodiments, the bottom lens is formed of an optically transmissive material including at least one of diffusion particles, scattering additives, surface roughness, or combinations thereof to cause scattering of the first optical distribution incident on the bottom lens.

In some embodiments, the refractor element comprises at least one wedge optic formed on or integrated with the body portion of the refractor element.

In some embodiments, a ratio of a total luminous flux emitted by the illumination apparatus with the bottom lens to a total luminous flux emitted in the absence of the bottom lens is at least 0.90, 0.95, or 0.98.

In some embodiments, a majority of the second portion of the first optical distribution incident on the inward protruding profile is reflected towards the refractor element and away from the housing and the at least one light source.

According to another aspect of the present disclosure, an illumination apparatus is disclosed. The illumination apparatus includes a housing, at least one light source, a refractor element and a bottom lens. The at least one light source is mounted on the housing and adapted to emit light into a first hemisphere centered about an optical axis forming a first optical distribution. The optical axis is oriented in a downward direction. The refractor element has a body portion surrounding the at least one light source and extends about the optical axis. The body portion defines a bottom opening. The bottom lens is disposed across at least a portion of the bottom opening to substantially enclose the bottom opening. The bottom lens includes a central portion having an inward protruding profile extending towards the at least one light source. At least a first portion of the first optical distribution is transmitted through the bottom lens into the first hemisphere. At least a second portion of the first optical distribution is reflected by the bottom lens to form a second optical distribution directed in an upward direction into a second hemisphere opposite the first hemisphere. A ratio of a total luminous flux emitted by the illumination apparatus with the bottom lens to a total luminous flux emitted in the absence of the bottom lens is at least 0.90, 0.95, or 0.98.

In some embodiments, a ratio of a maximum protrusion height to a lateral width of the bottom lens is at least 0.10, 0.20, 0.30, 0.40 or 0.50.

According to another aspect of the present disclosure, an illumination apparatus is disclosed. The illumination apparatus includes a housing, at least one light source, a refractor element and a bottom lens. The at least one light source is mounted on the housing and adapted to emit light into a first hemisphere centered about an optical axis forming a first optical distribution. The optical axis is oriented in a downward direction. The refractor element has a body portion surrounding the at least one light source and extends about the optical axis. The body portion defines a bottom opening. The bottom lens is disposed across at least a portion of the bottom opening to substantially enclose the bottom opening. The bottom lens includes a central portion having an inward protruding profile extending towards the at least one light source. At least a first portion of the first optical distribution is transmitted through the bottom lens into the first hemisphere. At least a second portion of the first optical distribution is reflected by the bottom lens to form a second optical distribution directed in an upward direction into a second hemisphere opposite the first hemisphere. A ratio of a maximum protrusion height to a lateral width of the bottom lens is at least 0.10, 0.20, 0.30, 0.40 or 0.50.

In some embodiments, a ratio of a total luminous flux emitted by the illumination apparatus with the bottom lens to a total luminous flux emitted in the absence of the bottom lens is at least 0.90, 0.95, or 0.98.

According to a further aspect of the present disclosure, an illumination apparatus is disclosed. The illumination apparatus includes at least one light source, an uplight optic, and a wedge optic. The at least one light source is adapted to emit light rays about an optical axis within a first hemisphere forming a first optical distribution. The first optical distribution is substantially rotationally symmetrical about the optical axis. The first optical distribution includes at least a first zone defined by a first set of light rays, a second zone defined by a second set of light rays, and a third zone defined by a third set of light rays. The first zone is emitted at an angle greater than that of the second zone relative to the optical axis, and the second zone is emitted at an angle greater than that of the third zone relative to the optical axis. The uplight optic is disposed to receive the first zone and reflect the first zone into a second hemisphere opposite the first hemisphere to form an uplight distribution. The wedge optic is disposed to intercept at least a portion of the second zone. The wedge optic is adapted to transmit and refract the intercepted portion such that refracted light rays exit the wedge optic at an angle to the optical axis greater than an entrance angle of the intercepted portion relative to the optical axis. The refracted light rays form a refracted zone distributed at angles wider than the second zone. The third zone propagates within the first hemisphere without angular redirection by the uplight optic and the wedge optic.

In some embodiments, the refracted zone formed by the refracted light rays is distributed within the first hemisphere.

In some embodiments, the wedge optic comprises a first surface and a second surface arranged to form a wedge-shaped refractive structure adapted to refract the intercepted portion of the second zone.

In some embodiments, the first surface and the second surface are adapted to increase an angular propagation direction of the intercepted portion relative to the optical axis by refraction.

In some embodiments, the wedge optic is formed from an optically transmissive material selected from polymethyl methacrylate (PMMA), polycarbonate, silicone, or glass.

In some embodiments, the wedge optic includes a plurality of wedge structures arranged sequentially.

In some embodiments, the wedge optic comprises linear grooves or prismatic structures adapted to transmit and refract the intercepted portion of the second zone.

In some embodiments, a minority portion of the refracted light rays is scattered into the second hemisphere.

In some embodiments, a minority portion of the refracted light rays is scattered at an angle smaller than an emission angle of the second zone relative to the optical axis.

In some embodiments, the wedge optic includes a textured surface, diffusant material, or surface irregularities adapted to scatter a portion of the transmitted light.

In some embodiments, the uplight optic reflects the first zone by total internal reflection generated by a plurality of linear prisms arranged to redirect incident light rays.

In some embodiments, the uplight optic reflects the first zone using a reflective surface comprising a metallic mirror or a dielectric mirror.

According to a further aspect of the present disclosure, an illumination apparatus is disclosed. The illumination apparatus includes at least one light source and a wedge optic. The at least one light source is adapted to emit light rays about an optical axis within a first hemisphere forming a first optical distribution. The first optical distribution is substantially rotationally symmetrical about the optical axis. The first optical distribution includes at least a first zone defined by a first set of light rays, and a second zone defined by a second set of light rays. The first zone is emitted at an angle greater than that of the second zone relative to the optical axis. The wedge optic is disposed to intercept at least a portion of the first zone. The wedge optic is adapted to transmit and refract the intercepted portion such that refracted light rays exit the wedge optic at an angle to the optical axis greater than an entrance angle of the intercepted portion relative to the optical axis. The refracted light rays form a refracted zone distributed within the first hemisphere at angles wider than the first zone. The second zone propagates within the first hemisphere without angular redirection by the wedge optic.

To further clarify the advantages and features of the present disclosure, a more particular description of the specific embodiments will be rendered by reference to specific embodiments thereof, which are illustrated in the appended drawings. It is appreciated that these drawings depict only typical embodiments of the invention and are therefore not to be considered limiting its scope. The invention will be described and explained with additional specificity and detail with the accompanying drawings.

### BRIEF DESCRIPTION OF THE DRAWINGS

Various embodiments disclosed herein will be better understood from the following detailed description when read with the accompanying drawings. The accompanying drawings constitute a part of the description and are used to provide a further understanding of the present disclosure through illustration of certain embodiments. The embodiments are illustrated by way of example and not by way of limitation in the figures of the accompanying drawings. Further, components and elements shown in the drawings are not necessarily to scale, emphasis instead being placed upon clearly illustrating the principles of the present disclosure. For consistency and ease of understanding, similar components and elements are annotated by reference numerals in the exemplary drawings. In the drawings:

FIG. 1A illustrates a two-dimensional (2D) representation of an illumination apparatus including a refractor element with a bottom opening, in accordance with an embodiment of the present disclosure.

FIG. 1B illustrates a 2D representation of an illumination apparatus with a bottom lens disposed across the bottom opening, in accordance with an embodiment of the present disclosure.

FIG. 1C illustrates a perspective view of the bottom lens including a plurality of elongated features, in accordance with an embodiment of the present disclosure.

FIG. 1D illustrates a cutaway perspective view of the bottom lens, in accordance with an embodiment of the present disclosure.

FIG. 1E illustrates a 2D cross-sectional view of the bottom lens, in accordance with an embodiment of the present disclosure.

FIG. 1F illustrates an enlarged view of a portion of the bottom lens showing the elongated features formed on an internal surface of the bottom lens, in accordance with an embodiment of the present disclosure.

FIG. 2 illustrates a schematic representation of an example illumination apparatus, in accordance with an embodiment of the present disclosure.

FIG. 3 illustrates a schematic representation of another example illumination apparatus, in accordance with an embodiment of the present disclosure.

FIG. 4A illustrates a schematic representation showing optical interaction of light rays with a wedge optic of the illumination apparatus described with reference to FIG. 3, in accordance with an embodiment of the present disclosure.

FIG. 4B illustrates a schematic representation showing optical interaction of the light rays with an alternate configuration of the wedge optic, in accordance with an embodiment of the present disclosure.

FIG. 5A illustrates a perspective view of an assembled luminaire incorporating an illumination apparatus, in accordance with an embodiment of the present disclosure.

FIG. 5B illustrates an exploded view of the luminaire shown in FIG. 5A, in accordance with an embodiment of the present disclosure.

FIG. 6A illustrates a perspective view of a refractor of the luminaire of FIG. 5A, in accordance with an embodiment of the present disclosure.

FIG. 6B illustrates another perspective view of the refractor of the luminaire of FIG. 5A, in accordance with an embodiment of the present disclosure.

FIG. 6C illustrates a top view of the refractor, in accordance with an embodiment of the present disclosure.

FIG. 6D illustrates a cross-sectional view of the refractor taken along a section line of FIG. 6C, in accordance with an embodiment of the present disclosure.

FIG. 6E illustrates an enlarged view of a cross-section shown in FIG. 6D, in accordance with an embodiment of the present disclosure.

FIG. 6F illustrates a side view of the refractor, in accordance with an embodiment of the present disclosure.

FIG. 6G illustrates a cross-sectional view of the refractor taken along a section line of FIG. 6F, in accordance with an embodiment of the present disclosure.

FIG. 6H illustrates an enlarged detail view corresponding to a portion of the cross-section shown in FIG. 6G, in accordance with an embodiment of the present disclosure.

FIG. 7A illustrates a perspective view of an alternate embodiment of a refractor, in accordance with an embodiment of the present disclosure.

FIG. 7B illustrates an enlarged view of a surface region of the refractor of FIG. 7A, in accordance with an embodiment of the present disclosure.

FIG. 7C illustrates a side view of the refractor, in accordance with an embodiment of the present disclosure.

FIG. 7D illustrates a cross-sectional view of the refractor taken along a section line of FIG. 7C, in accordance with an embodiment of the present disclosure.

FIG. 7E illustrates an enlarged detail view corresponding to a portion of a refractor surface shown in FIG. 7D, in accordance with an embodiment of the present disclosure.

FIGS. 8A through 8C illustrate various views of an uplight optic, in accordance with an embodiment of the present disclosure.

FIG. 9 illustrates a schematic representation of an illumination apparatus, in accordance with an embodiment of the present disclosure.

Further, skilled artisans will appreciate that elements in the drawings are illustrated for simplicity and may not have necessarily been drawn to scale. For example, in terms of the construction of the device, one or more components of the device may have been represented in the drawings by conventional symbols, and the drawings may show only those specific details that are pertinent to understanding the embodiments of the invention so as not to obscure the drawings with details that will be readily apparent to those of ordinary skill in the art having the benefit of the description herein.

### DETAILED DESCRIPTION OF THE INVENTION

Inventive concepts of the present disclosure will now be described more fully hereinafter with reference to the accompanying drawings, in which examples of one or more embodiments of inventive concepts are shown. Inventive concepts may, however, be embodied in different forms and should not be construed as limited to the embodiments set forth herein. Further, the one or more embodiments disclosed herein are provided to describe the inventive concept thoroughly and completely, and to fully convey the scope of each of the present inventive concepts to those skilled in the art.

Furthermore, it should be noted that the embodiments disclosed herein are not mutually exclusive concepts. Accordingly, one or more components from one embodiment may be tacitly assumed to be present or used in any other embodiment.

The following description presents various embodiments of the present disclosure. The embodiments disclosed herein are presented as teaching examples and are not to be construed as limiting the scope of the present disclosure. The present disclosure should in no way be limited to the illustrative implementations, drawings, and techniques illustrated below, including the exemplary design and implementation illustrated and described herein, but may be modified, omitted, or expanded upon without departing from the scope of the present disclosure.

The following description contains specific information pertaining to embodiments in the present disclosure. The detailed description uses the phrases “in some embodiments” or “some implementations” which may each refer to one or more or all of the same or different embodiments or implementations. The term “some” as used herein is defined as “one, or more than one, or all.” Accordingly, the terms “one,” “more than one,” “more than one, but not all” or “all” would all fall under the definition of “some.” In view of the same, the terms, for example, “in an embodiment” or “in an implementation” refers to one embodiment or one implementation and the term, for example, “in one or more embodiments” refers to “at least one embodiment, or more than one embodiment, or all embodiments”. Further, the term, for example, “in one or more implementations” refers to “at least one implementation, or more than one implementation, or all implementations”.

The term “comprising,” when utilized, means “including, but not necessarily limited to;” it specifically indicates open-ended inclusion in the so-described one or more listed features, elements in a combination, unless otherwise stated with limiting language. Furthermore, to the extent that the terms “includes,” “has,” “have,” “contains,” and other similar words are used in either the detailed description, such terms are intended to be inclusive in a manner similar to the term “comprising.”

In the following description, for the purposes of explanation, various specific details are set forth to provide a thorough understanding of embodiments of the present disclosure. It will be apparent, however, that embodiments of the present disclosure may be practiced without these specific details. Several features described hereafter may each be used independently of one another or with any combination of other features.

The description provided herein discloses exemplary embodiments only and is not intended to limit the scope, applicability, or configuration of the present disclosure. Rather, the foregoing description of the exemplary embodiments will provide those skilled in the art with an enabling description for implementing any of the exemplary embodiments. Specific details are given in the following description to provide a thorough understanding of the embodiments. However, it may be understood by one of the ordinary skil in the art that the embodiments disclosed herein may be practiced without these specific details.

The terminology used herein is for the purpose of describing particular embodiments only and is not intended to be limiting of the disclosure. As used herein in the description, the singular forms “a”, “an”, and “the” include plural forms unless the context of the invention indicates otherwise.

The terminology and structure employed herein are for describing, teaching, and illuminating some embodiments and their specific features and elements and do not limit, restrict, or reduce the scope of the present disclosure. Accordingly, unless otherwise defined, all terms, and especially any technical and/or scientific terms used herein may be taken to have the same meaning as commonly understood by one having ordinary skill in the art.

Illumination apparatuses employing solid-state light sources, such as light-emitting diodes (LEDs), are often utilized to provide efficient and controlled light distribution for a variety of lighting applications. In many lighting systems, light emitted from a light source propagates into a hemispherical region and forms an optical distribution including portions emitted at different angular regions relative to an optical axis. Without appropriate optical control, portions of the emitted light may propagate in undesirable directions, may be absorbed by structural components of the luminaire, or may otherwise be lost within the optical assembly. Such conditions can result in reduced optical efficiency and ineffective utilization of emitted luminous flux.

In addition, the lighting systems require precise control over distribution of different portions of the emitted optical distribution within an illuminated space. A portion of the emitted optical distribution may contribute to useful illumination, while other portion may produce undesirable glare or propagate outside intended illumination regions. Efficient lighting systems therefore benefit from optical arrangements capable of controlling the propagation of emitted light in order to achieve effective illumination while reducing glare and minimizing loss of the emitted light.

The present disclosure provides an illumination apparatus adapted to improve control over propagation of light emitted from a light source. In particular, the disclosed illumination apparatus employs optical arrangements positioned relative to the light source and other structural components to influence propagation of different portions of the emitted optical distribution within and outside the illumination apparatus.

In various embodiments, the illumination apparatus may include optical elements adapted to interact with selected portions of the emitted optical distribution such that the selected portions of the emitted optical distribution are redirected, transmitted, refracted, or otherwise modified while other portions of the emitted optical distribution propagate substantially unchanged. Through such optical interaction, the emitted optical distribution can be redistributed into desired angular regions relative to an optical axis.

By influencing the propagation of different portions of the emitted optical distribution, the illumination apparatus facilitates reduction in loss of emitted light, improved optical efficiency, and improved control over the spatial distribution of light produced by the illumination system. In certain implementations, such control may enable formation of a structured optical distribution suitable for a variety of lighting applications.

Accordingly, the present disclosure provides an illumination apparatus capable of controlling the propagation of emitted light through cooperative interaction between a light source and optical elements arranged within the illumination apparatus, thereby enabling improved distribution of emitted light while maintaining desired illumination characteristics.

An aspect of the present disclosure is to provide an illumination apparatus that can control propagation of emitted light in order to achieve a desired spatial light distribution.

Another aspect of the present disclosure is to provide an illumination apparatus including optical elements that can influence propagation of different portions of an emitted optical distribution.

Yet another aspect of the present disclosure is to provide an illumination apparatus that can redistribute portions of emitted light while allowing other portions of the emitted light to propagate substantially unchanged.

A further aspect of the present disclosure is to provide an illumination apparatus including optical structures that can redirect selected portions of an emitted optical distribution into different angular regions relative to an optical axis.

It is also an aspect of the present disclosure to provide an illumination apparatus capable of reducing loss of emitted luminous flux by redirecting light that would otherwise propagate in undesirable directions.

Still another aspect of the present disclosure is to provide an illumination apparatus capable of forming a structured optical distribution by selectively transmitting, refracting, or reflecting portions of emitted light.

An additional aspect of the present disclosure is to provide an illumination apparatus including optical elements adapted to influence glare characteristics and perceived brightness of a light source.

Another aspect of the present disclosure is to provide an illumination apparatus including optical components arranged to improve optical efficiency while maintaining desired illumination characteristics.

In order to facilitate an understanding of the present disclosure, certain technical terms used throughout the specification and claims are defined below. These definitions are provided for clarity and are not intended to limit the scope of the present disclosure unless explicitly stated.

The term “illumination apparatus” refers to a device or assembly adapted to emit visible light for illumination purposes and may include one or more light sources, optical elements, structural components, electrical components, and thermal management structures arranged to generate a desired light distribution.

The term “luminaire” refers to a lighting device including a light source and associated components such as optical elements, structural supports, and electrical drivers adapted to produce and distribute light.

The term “light source” refers to any device or component capable of emitting electromagnetic radiation in the visible spectrum when energized. Throughout the present disclosure, the light source may correspond to a light emitting diode (LED) alone or an LED in combination with an optic.

The term “light-emitting diode (LED)” refers to a semiconductor device that emits optical radiation when electrically energized due to electroluminescence in a semiconductor junction. The LED may be provided as an individual semiconductor chip, a packaged LED component, a chip-on-board assembly, an LED array, a micro-LED, or another solid-state light-emitting structure suitable for illumination.

The term “optical axis” refers to a reference axis associated with an optical system or optical element and used to describe symmetry, alignment, or angular propagation of light within the optical system. In the context of the present disclosure, the optical axis may correspond to a central axis about which the emitted optical distribution is substantially rotationally symmetrical.

The term “optical distribution” refers to a spatial and angular distribution of light intensity as a function of direction from a light source or after interaction with one or more optical elements. In the context of the present disclosure, the optical distribution may include one or more zones defined according to angular position relative to the optical axis.

The term “light ray” refers to an idealized geometric representation of a direction of propagation of light or of a portion of light energy within an optical system. In the context of the present disclosure, a light ray may represent an individual propagation path or a representative direction of a bundle of light.

The term “zone” refers to a selected portion or sub-region of an optical distribution, the selected portion being identifiable by one or more propagation directions, angular ranges, bundles of light rays, or representative light rays relative to an optical axis. In the context of the present disclosure, a zone may correspond to an angular portion of the optical distribution.

The term “first optical distribution” refers to an initial optical distribution emitted by a light source before interaction with other optical elements. In the context of the present disclosure, the first optical distribution may be emitted directly by the LED or may be formed after light emitted by the LED passes through an optic associated with the LED.

The term “second optical distribution” refers to an optical distribution produced from at least a portion of the first optical distribution after interaction with one or more optical elements. The optical interaction may include reflection, refraction, transmission, scattering, redirection, or a combination thereof.

The term “hemisphere” refers to one half of a spherical region defined with respect to a reference point and an optical axis or a reference plane passing through the reference point. In the context of the present disclosure, a hemisphere may correspond to a set of propagation directions extending to one side of the reference point.

The term “first hemisphere” refers to a first half-space or first half-spherical region defined relative to the optical axis and corresponding to a first general direction of light propagation from the light source. In the context of the present disclosure, the first hemisphere generally corresponds to the primary emission side of the illumination apparatus.

The term “second hemisphere” refers to a second half-space or second half-spherical region defined relative to the optical axis and oriented opposite to the first hemisphere. The second hemisphere is distinct from the first hemisphere, and together the first hemisphere and the second hemisphere define a complete spherical set of propagation directions about the reference point.

The term “housing” refers to a structural component or assembly configured to support, position, mount, enclose, protect, or thermally couple one or more components of an illumination apparatus. In some embodiments, the housing may also function as a heat-dissipating structure, mounting interface, or protective enclosure for optical, electrical, and thermal components.

The term “refractor element” refers to an optical component formed from a light-transmissive material configured to modify propagation of light primarily through refraction.

The term “bottom opening” refers to an aperture defined by a structural or optical component through which light may propagate.

The term “bottom lens” refers to an optical element positioned across at least a portion of a bottom opening and adapted to interact with incident light.

The term “central portion” refers to a region of an optical element located generally along the optical axis.

The term “peripheral region” refers to a region of an optical element located radially outward from the central portion.

The term “inward protruding profile” refers to a portion of an optical element extending inward toward an interior region of an optical assembly.

The term “protrusion height” refers to a dimension measured along the optical axis between an apex of a protruding feature and a baseline plane of an optical element. In the context of the present disclosure, the baseline plane may correspond to a lowest point of the bottom lens or a mounting location of the bottom lens to the optical element.

The term “lateral width” refers to a width dimension measured across the optical element, or across an opening associated with the optical element, in a direction transverse to the optical axis. Unless otherwise stated, the lateral width corresponds to the maximum width.

The term “elongated features” refers to optical or surface features having a length greater than a transverse dimension thereof and extending along a selected direction across at least a portion of a surface.

The term “grooves” refers to recessed elongated channels or depressions formed in a surface.

The term “ridges” refers to raised elongated projections or formations extending from a surface.

The term “prisms” refers to optical structures having angled surfaces capable of redirecting light by refraction, reflection, total internal reflection, or a combination thereof.

The term “flutes” refers to elongated surface formations having concave, convex, wavelike, or channeled profiles that influence propagation of light incident thereon.

The term “transmission” refers to propagation of light through an optical medium such that the light enters the medium at an incident surface and exits the medium at an opposing surface without being absorbed or completely reflected.

The term “reflection” refers to a process in which incident light is redirected at an interface between two materials such that the light remains within the incident medium rather than propagating into the second medium. Reflection may occur as specular reflection, where the angle of reflection equals the angle of incidence, or as diffuse reflection, where the light is redirected in multiple directions.

The term “refraction” refers to the change in direction of propagation of light as the light passes across an interface between two materials having different refractive indices. The change in propagation direction occurs due to a change in the velocity of light in the different media.

The term “scattering” refers to the redirection of light in multiple directions as a result of interaction with particles, surface structures, or inhomogeneities within or on an optical material. Scattering may occur due to microscopic surface roughness, embedded particles, or structural variations within a medium and may produce diffuse propagation of light rather than a single deterministic propagation direction.

The term “wedge optic” refers to an optical element adapted to receive incident light and alter the propagation direction of at least a portion of the incident light by refraction through one or more surfaces arranged at different angular orientations. In the context of the present disclosure, the wedge optic may include one or more wedge-shaped refractive structures, segments, grooves, prisms, or surface portions configured to increase an angular propagation direction of intercepted light relative to an optical axis.

The term “uplight optic” refers to an optical element adapted to redirect at least a portion of light emitted from a light source toward a hemisphere opposite a primary emission hemisphere. Such redirection may occur by reflection, total internal reflection, refraction, scattering, or a combination thereof. In the context of the present disclosure, the uplight optic may receive a selected zone of an optical distribution and redirect the selected zone into the second hemisphere to form an uplight distribution.

The term “optically transmissive material” refers to a material capable of transmitting a substantial portion of incident optical radiation, including visible light, with relatively low absorption and without preventing intended optical propagation through the material. Examples of optically transmissive materials may include acrylic, polymethyl methacrylate (PMMA), polycarbonate, glass, silicone, or other transparent or translucent optical-grade materials.

The term “diffusion particles” refers to particles, inclusions, or dispersed constituents disposed within an optical material and adapted to scatter light propagating through the optical material. The diffusion particles may be selected in size, shape, concentration, or refractive index to influence a desired degree of diffusion or haze.

The term “surface roughness” refers to microscopic or fine-scale irregularities, texture, or deviations present on a surface of an optical element, the irregularities being capable of affecting reflection, transmission, refraction, diffusion, or scattering of incident light.

The term “luminous flux” refers to the total quantity of visible light emitted, transmitted, or otherwise propagated per unit time, as weighted by the spectral response of the human eye. Luminous flux is commonly expressed in lumens.

The term “illumination efficiency” refers to a relative optical performance parameter represented by a ratio of luminous flux in one configuration to luminous flux in a reference configuration. An illumination efficiency of 100% indicates substantially no reduction in luminous flux relative to the reference configuration, while an illumination efficiency of 95% indicates that about 95% of the luminous flux is retained and about 5% is lost relative to the reference configuration.

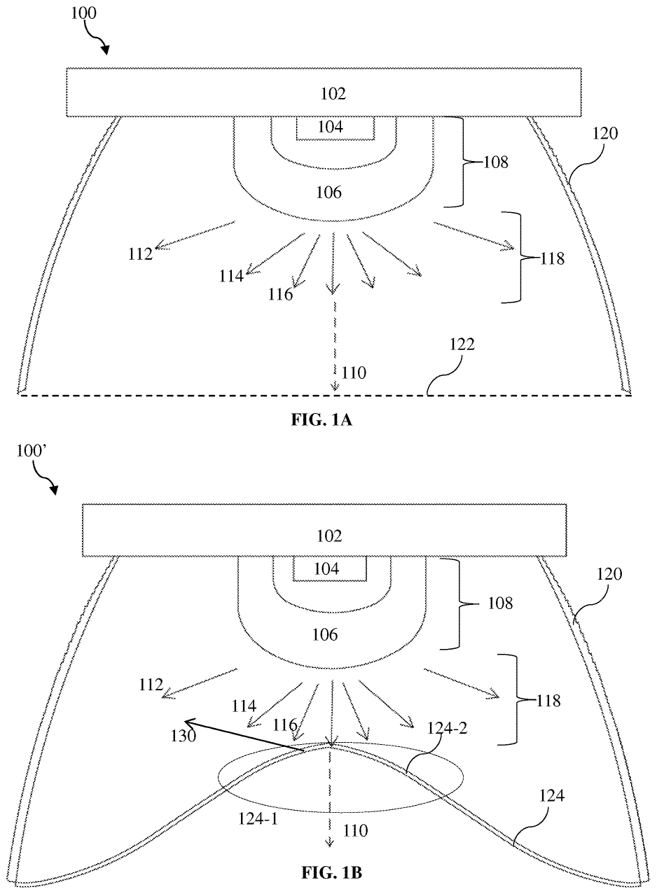

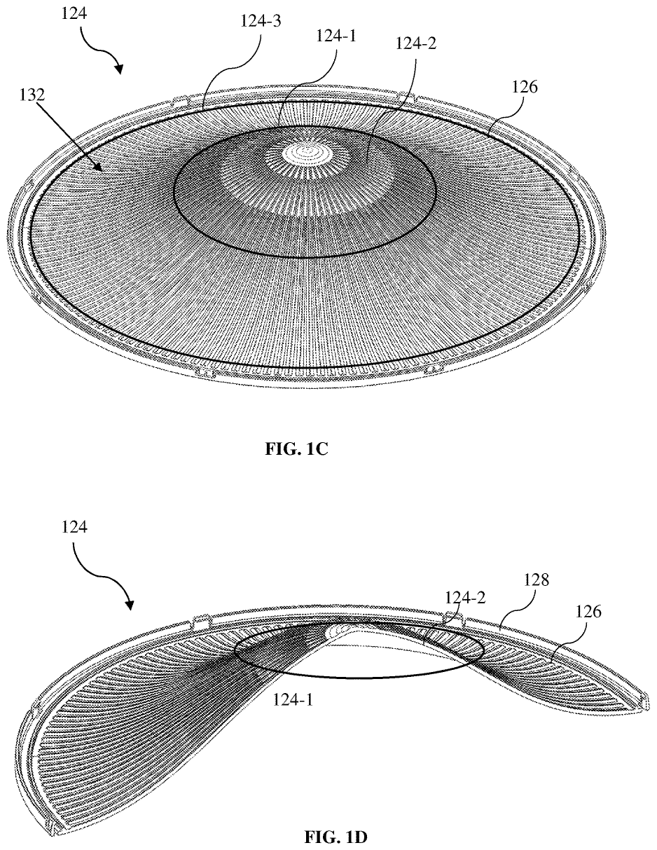

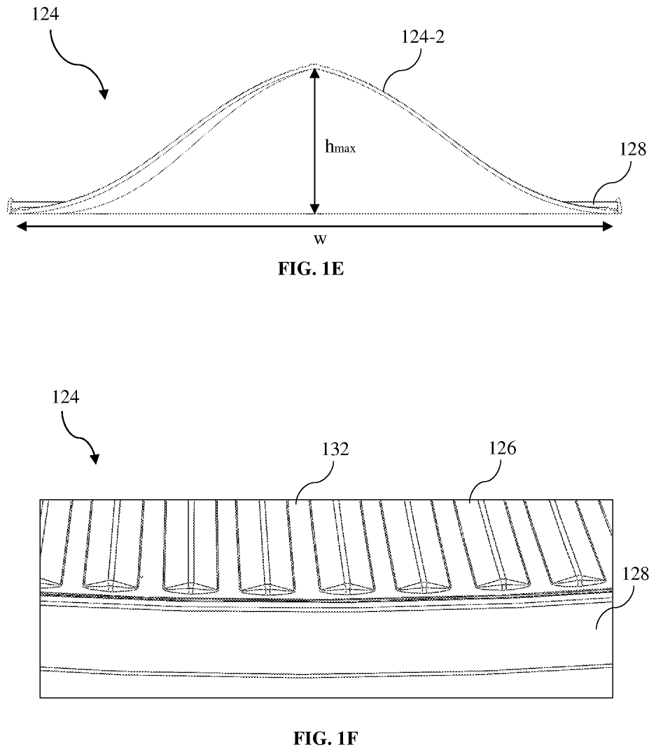

Embodiments of the present disclosure will now be described with reference to FIG. 1A through FIG. 9.

FIG. 1A illustrates a two-dimensional (2D) representation of an illumination apparatus 100 including a refractor element 120 with a bottom opening 122, in accordance with an embodiment of the present disclosure.

The illumination apparatus 100 includes a housing 102 adapted to support and position one or more light-emitting components and associated optical elements. The housing 102 may be formed from a thermally conductive material, such as metal or a metal alloy, and may function as part of a heat-dissipating structure for removing heat generated by internal electronic and optical components. The housing 102 may further integrate additional components such as a metal-core printed circuit board (MCPCB) and driver electronics, which support electrical connectivity and regulate the operation of the light-emitting elements.

The illumination apparatus 100 further includes a light source 108 mechanically connected to the housing 102 and adapted to emit light for illumination. In the illustrated embodiment, the light source 108 includes a light-emitting diode (LED) 104 and an optional optic 106 (hereinafter may also be referred to as “an optic 106”) positioned adjacent to the LED 104. The optic 106 may correspond to an optical element adapted to intercept and redirect light emitted by the LED 104. In some embodiments, the optic 106 may include a lens, reflector, or other optical structure designed to influence the distribution of emitted light.

The light emitted from the light source 108 propagates about an optical axis 110. The optical axis 110 defines a central reference axis of the illumination apparatus 100 and extends in a direction as illustrated in FIG. 1A. Light emitted from the light source 108 forms a first optical distribution 118 that propagates within a first hemisphere centered about the optical axis 110.

In some embodiments, the light source 108 may consist solely of the LED 104 without the inclusion of the optic 106, such that the first optical distribution 118 is emitted directly from the LED 104.

For purposes of describing the angular propagation of the emitted light, the first optical distribution 118 may be conceptually divided into multiple angular regions relative to the optical axis 110. These angular regions correspond to different portions of the emitted light distribution and may be referred to as zones of the first optical distribution 118. The zones of the first optical distribution 118 include a first zone 112, a second zone 114, and a third zone 116. The first zone 112 corresponds to light rays emitted at relatively larger angles from the optical axis 110, the second zone 114 corresponds to light rays emitted at intermediate angular positions relative to the optical axis 110, and the third zone 116 corresponds to light rays emitted at relatively smaller angles relative to the optical axis 110.

The illumination apparatus 100 further includes the refractor element 120 disposed around the light source 108. The refractor element 120 includes a body portion extending circumferentially about the optical axis 110 and surrounding the light source 108.

In some embodiments, the refractor element 120 may include, on an outer surface thereof, a plurality of wedge portions arranged sequentially along a circumferential extent of the refractor element 120. The wedge portions may define wedge-shaped optical structures formed on the outer surface of the refractor element 120 and may extend circumferentially around the optical axis 110. Each wedge portion may include one or more inclined surfaces configured to influence propagation of light interacting with the refractor element 120.

The plurality of wedge portions may collectively form a wedge optic integrated with the body portion of the refractor element 120. In some embodiments, the wedge portions may be arranged in a repeating pattern or sequential array around the refractor element 120. The wedge portions may be configured to redirect, refract, or otherwise modify propagation of light rays interacting with the refractor element 120.

In some embodiments, the wedge portions may be configured to redirect light rays incident on the refractor element 120 such that the propagation direction of the light rays is modified relative to the optical axis 110. The wedge portions may therefore function as a wedge optic capable of influencing angular propagation of light emitted from the light source 108.

The refractor element 120 may be formed from an optically transmissive material such as glass, acrylic, polycarbonate, silicone, a polymeric material, or other suitable optical material capable of transmitting and modifying the propagation of light emitted from the light source 108.

The body portion of the refractor element 120 defines a bottom opening 122 located below the light source 108 along the optical axis 110. The bottom opening 122 provides a pathway through which light from the first optical distribution 118 may propagate outward from the illumination apparatus 100 into the surrounding environment.

As illustrated in FIG. 1A, light rays corresponding to the first zone 112, the second zone 114, and the third zone 116 propagate outwards from the light source 108 and towards the bottom opening 122 and toward interior surfaces of the refractor element 120. In the configuration shown in FIG. 1A, portions of the first optical distribution 118 may propagate directly through the bottom opening 122.

FIG. 1B illustrates a two-dimensional (2D) representation of an illumination apparatus 100′ including a bottom lens 124 disposed across the bottom opening 122, in accordance with an embodiment of the present disclosure.

The illumination apparatus 100′ includes the housing 102, the light source 108 mounted on the housing 102, and the refractor element 120 surrounding the light source 108, as previously described with respect to FIG. 1A. The refractor element 120 extends circumferentially about the optical axis 110 and defines the bottom opening 122 through which light emitted from the light source 108 may propagate.

The bottom lens 124 is disposed across at least a portion of the bottom opening 122 of the refractor element 120. In some embodiments, the bottom lens 124 may be supported by a peripheral region of the refractor element 120 or by another structural feature of the illumination apparatus 100′ such that the bottom lens 124 substantially encloses the bottom opening 122.

The bottom lens 124 includes a central portion 124-1 that is generally aligned with the optical axis 110. The central portion 124-1 includes an inward protruding profile 124-2 extending toward the light source 108 and away from the bottom opening 122. In the illustrated embodiment, the inward protruding profile 124-2 forms a dome-shaped or curved structure projecting toward the light source 108.

The light source 108 emits light forming the first optical distribution 118, which propagates within a first hemisphere centered about the optical axis 110. As previously described with respect to FIG. 1A, the first optical distribution 118 may include multiple angular zones relative to the optical axis 110, including the first zone 112, the second zone 114, and the third zone 116, corresponding to the portions of the emitted light propagating at different angular ranges relative to the optical axis 110.

A first portion of the first optical distribution 118 propagates toward the bottom lens 124 and is transmitted through the bottom lens 124 into the first hemisphere below the illumination apparatus 100′. Transmission of the first portion of the optical distribution allows the light to propagate outward from the illumination apparatus 100′ to provide downward illumination.

A second portion of the first optical distribution 118 is incident on the inward protruding profile 124-2 of the bottom lens 124. At least a portion of the incident light rays may be reflected by the surface of the inward protruding profile 124-2. The reflected light forms a second optical distribution 130 directed upward and toward a second hemisphere opposite the first hemisphere.

In some embodiments, the inward protruding profile 124-2 is adapted such that the reflected second optical distribution 130 is directed away from the housing 102 and the light source 108 and towards the refractor element 120. The reflected light may subsequently interact with optical surfaces of the refractor element 120, including a plurality of wedge portions arranged sequentially along an outer surface of the refractor element 120, which further influences the propagation and redistribution of the reflected light. In some embodiments, a substantial portion i.e., a majority of the reflected second optical distribution 130 is directed away from the housing 102 and the light source 108. In some other embodiments, at least about 70%, 80%, or 90% of the second optical distribution 130 may be directed away from the housing 102 and the light source 108, thereby enhancing optical redistribution through the refractor element 120.

In some embodiments, the bottom lens 124 may be formed from an optically transmissive material such as glass, acrylic, polycarbonate, polymeric materials, silicone, or other suitable optical materials. The bottom lens 124 may further include optical features configured to influence the propagation of light passing through or reflecting from the bottom lens 124, including diffusion particles, scattering additives, surface roughness, or other surface structures that cause scattering or redistribution of the first optical distribution 118 incident on the bottom lens 124.

In certain embodiments, the geometry of the inward protruding profile 124-2 may be characterized by a protrusion height ‘h’, measured along the optical axis 110 relative to a baseline plane of the bottom lens 124. In some configurations, the protrusion height ‘h’ may be selected to control the proportion of light transmitted through the bottom lens 124 and the proportion of light redirected toward the refractor element 120, thereby influencing the overall spatial light distribution produced by the illumination apparatus 100′. In some embodiments, the protrusion height ‘h’ is defined as a vertical distance between the baseline plane of the bottom lens 124 and a highest inwardly protruding point of the profile 124-2 along the optical axis 110.

In the context of the present disclosure, in an implementation, the baseline plane corresponds to a plane/level of the bottom opening 122, when the bottom lens 124 terminates at the opening 122 without extending below it. In another implementation, the baseline plane refers to a plane defined by the lowest portion of the bottom lens profile when a portion of the bottom lens 124 extends downward beyond the bottom opening 122.

FIG. 1C illustrates a perspective view of the bottom lens 124 including a plurality of elongated features 126 (hereinafter may be referred to as the “elongated features 126”), in accordance with an embodiment of the present disclosure. The bottom lens 124 is adapted to be disposed across a portion of the bottom opening 122, as described with reference to FIG. 1B.

The bottom lens 124 includes the central portion 124-1 with a steeper slope and a surrounding portion 124-3 with a gradual slope. The bottom lens 124 is attached via fixing means (not shown in FIG.) to a peripheral region 128 of the body portion of the refractor element 120. The central portion 124-1 corresponds to a region of the bottom lens 124 that is aligned with the optical axis 110 when the bottom lens 124 is installed in the illumination apparatus 100′. In some embodiments, the central portion 124-1 may include the inward protruding profile 124-2 described with reference to FIG. 1B.

As illustrated in FIG. 1C, the bottom lens 124 further includes the elongated features 126 formed on an interior surface 132 of the bottom lens 124. The elongated features 126 extend radially outward from the central portion 124-1. The elongated features 126 are distributed circumferentially around the bottom lens 124 and extend substantially along radial directions relative to the optical axis 110 when the bottom lens 124 is installed in the illumination apparatus 100′. In certain embodiments, the elongated features 126 may be formed as repeated optical structures distributed around the circumference of the bottom lens 124.

The elongated features 126 may be formed as optical surface structures on the bottom lens 124 and may include grooves, ridges, flutes, prisms, or other refractive or light-modifying structures. In some embodiments, the elongated features 126 may define prismatic or fluted optical elements configured to influence propagation of the first optical distribution 118 incident on the bottom lens 124. For example, the elongated features 126 may modify propagation directions of incident light through refraction, partial reflection, or controlled scattering so as to redistribute light passing through the bottom lens 124.

In some embodiments, the elongated features 126 extend across a substantial portion of a radial span of the bottom lens 124 between the central portion 124-1 and an outer peripheral edge of the surrounding portion 124-3. The elongated features 126 may be arranged substantially uniformly around the circumference of the bottom lens 124 such that the optical characteristics of the bottom lens 124 remain generally symmetric about the optical axis 110. Such symmetric distribution of the elongated features 126 may facilitate uniform redistribution of light emitted from the illumination apparatus.

The peripheral region 128 of the bottom lens 124 may include structural features configured to facilitate mounting of the bottom lens 124 to the refractor element 120 or to another structural component of the illumination apparatus 100′. For example, the peripheral region 128 may include engagement features, retaining structures, or mounting elements configured to support and secure the bottom lens 124 within the illumination apparatus.

In operation, the elongated features 126 may cooperate with the inward protruding profile 124-2 of the bottom lens 124 to influence the spatial distribution and visual appearance of light emitted from the illumination apparatus 100′. For example, the elongated features 126 may redistribute or diffuse light transmitted through the bottom lens 124, thereby reducing direct visual perception of the light source 108, mitigating glare, and improving visual comfort while maintaining efficient transmission of light.

FIG. 1D illustrates a cutaway perspective view of the bottom lens 124, in accordance with an embodiment of the present disclosure. The cutaway configuration illustrates a three-dimensional (3D) geometry of the bottom lens 124 and a relationship between the inward protruding profile 124-2 and the elongated features 126 formed on the bottom lens 124.

The central portion 124-1 forms the inward protruding profile 124-2 that extends toward the light source 108 when the bottom lens 124 is installed in the illumination apparatus 100′. The inward protruding profile 124-2 forms a curved dome-like geometry that rises gradually from the outer peripheral edge of the surrounding portion 124-3 and at steeper angle from the surrounding portion 124-3 towards the central portion 124-1 of the bottom lens 124.

The elongated features 126 follow the curvature of the bottom lens 124 such that the surface structures conform to the overall dome-like geometry of the inward protruding profile 124-2.

In operation, the curved geometry of the inward protruding profile 124-2 together with the elongated features 126 may influence how light interacts with the bottom lens 124. Depending on the angle of incidence and the local surface geometry, portions of the incident light may be transmitted, redirected, or scattered as the light interacts with the optical surface of the bottom lens.

FIG. 1E illustrates a two-dimensional cross-sectional side view of the bottom lens 124, in accordance with an embodiment of the present disclosure.

The inward protruding profile 124-2 forms a curved dome-like geometry extending towards a central apex located generally along the optical axis 110. The bottom lens 124 transitions gradually in the surrounding portion 124-3 and then steeply in the central portion 124-1, thereby forming a continuously curved profile.

The inward protruding profile 124-2 may be characterized by a maximum protrusion height hₘₐₓ measured along the optical axis 110 relative to the baseline plane of the bottom lens 124.

The geometry of the bottom lens 124 further defines a lateral width ‘w’, which corresponds to a maximum horizontal span of the bottom lens. In some embodiments, a ratio between the maximum protrusion height hₘₐₓ and the lateral width w of the bottom lens 124 may be selected within a predetermined range in order to influence the optical interaction between the bottom lens 124 and the first optical distribution 118 emitted by the light source 108.

Selection of the geometric relationship between the protrusion height ‘h’ and the lateral width ‘w’ may influence the manner in which light interacts with the inward protruding profile of the bottom lens, including redistribution of incident light, reduction of direct visibility of the light source, and modification of the spatial distribution of light emitted from the illumination apparatus 100′.

FIG. 1F illustrates an enlarged view of a portion of the bottom lens 124 showing the elongated features 126 formed on the internal surface 132 of the bottom lens 124, in accordance with an embodiment of the present disclosure.

The elongated features 126 are formed as repeating surface structures extending along the radial direction when the bottom lens 124 is installed within the illumination apparatus 100′. The enlarged representation illustrates the local surface geometry of the elongated features 126 formed along the curved internal surface 132 of the bottom lens 124.

In certain embodiments, the elongated features 126 may define a groove-like or prismatic structure formed in the internal surface 132 of the bottom lens 124. The elongated features 126 may include side surfaces that extend from a base surface of the bottom lens 124 and converge toward a ridge or vertex portion, thereby defining a light-modifying surface structure.

The cross-sectional geometry of the elongated features 126 may include triangular, trapezoidal, curved, or other prismatic profiles. Such geometries may be selected to influence the interaction of incident light with the bottom lens 124, including modifying the direction of transmitted light through refraction or introducing controlled diffusion of light passing through the bottom lens 124.

In some embodiments, the spacing, depth, or profile of the elongated features 126 may vary along the surface of the bottom lens 124. Variations in these geometric characteristics may be used to influence optical behavior across different regions of the bottom lens 124. The elongated features 126 may therefore function as light-modifying surface structures configured to influence the distribution of light transmitted through the bottom lens 124.

In various embodiments, the elongated features 126 described with reference to FIGS. 1C-1F may collectively define a plurality of optical surface microstructures formed on the bottom lens 124. The microstructures may include refractive, reflective, or diffusive surface geometries configured to influence propagation of light interacting with the bottom lens. Although the elongated features 126 are illustrated as radially extending structures in the embodiments shown, the optical surface microstructures may alternatively be formed in other arrangements, including curved, segmented, concentric, or non-uniform patterns, depending on the desired optical characteristics of the illumination apparatus. The geometry, spacing, orientation, and surface profile of the elongated features 126 may therefore be selected to achieve a desired redistribution of light emitted from the light source while maintaining optical efficiency and visual comfort.

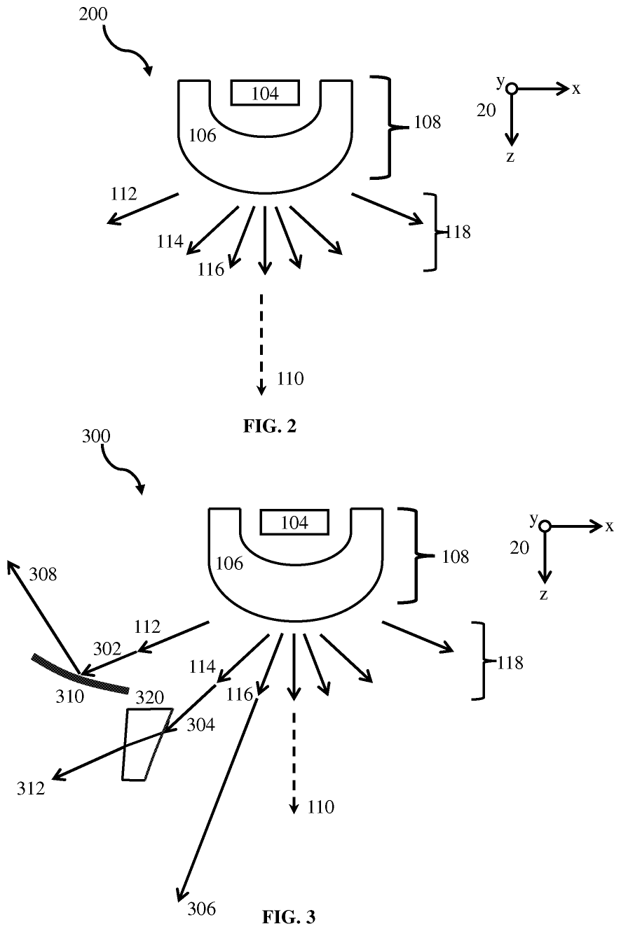

FIG. 2 illustrates a schematic representation of an example illumination apparatus 200 (hereinafter may also be referred to as “an illumination apparatus 200”), in accordance with an embodiment of the present disclosure.

The illumination apparatus 200 includes at least one light source 108 configured to emit light rays about the optical axis 110. The optical axis 110 represents a principal propagation direction of light emitted from the light source 108 and may correspond to a central axis of symmetry of the illumination apparatus 200. In the illustrated embodiment, the optical axis 110 extends vertically and defines a reference axis relative to which angular propagation of emitted light may be characterized.

The light source 108 may include one or more solid-state light emitters such as light-emitting diodes (LEDs), chip-on-board (COB) light emitters, LED arrays, or other suitable light-emitting devices capable of producing visible light. In some embodiments, the light source 108 may optionally include one or more optical elements 106 positioned adjacent to the LED 104.

Light emitted from the light source 108 propagates outward from the optical axis 110 and forms the first optical distribution 118. The first optical distribution 118 propagates within a first hemisphere centered about the optical axis 110. The first hemisphere corresponds to a spatial region extending in a downward direction relative to the illumination apparatus 200, while a spatial region in an opposite direction (upward) relative to the optical axis 110 corresponds to a second hemisphere that is distinct from and non-overlapping with the first hemisphere. The first hemisphere and the second hemisphere together form a sphere.

As schematically illustrated in FIG. 2, the first optical distribution 118 may be conceptually divided into multiple angular regions relative to the optical axis 110. In particular, the first optical distribution 118 includes the first zone 112, the second zone 114, and the third zone 116.

The first zone 112 corresponds to a portion of the first optical distribution 118 that is emitted at relatively larger angles relative to the optical axis 110. Light rays associated with the first zone 112 therefore propagate farther away from the optical axis as compared with other portions of the optical distribution.

The second zone 114 corresponds to an intermediate angular region of the first optical distribution 118. Light rays associated with the second zone 114 propagate at angles relative to the optical axis 110 that are smaller than those of the first zone 112 but larger than those of the third zone 116.

The third zone 116 corresponds to a portion of the first optical distribution 118 emitted at relatively smaller angles relative to the optical axis 110. Light rays associated with the third zone 116 therefore propagate generally closer to the optical axis.

In the illustrated embodiment, the first zone 112 is emitted at an angle greater than that of the second zone 114 relative to the optical axis 110, and the second zone 114 is emitted at an angle greater than that of the third zone 116 relative to the optical axis 110. The zonal representation shown in FIG. 2 therefore illustrates a hierarchical angular arrangement of emitted light relative to the optical axis.

The conceptual division of the first optical distribution 118 into the first zone 112, the second zone 114, and the third zone 116 provides a framework for describing how different portions of the emitted light distribution may subsequently interact with optical elements within the illumination apparatus. In particular, different optical components may be arranged to selectively intercept, redirect, transmit, or otherwise modify one or more of the zones of the first optical distribution in order to produce a desired spatial distribution of light.

FIG. 3 illustrates a schematic representation of another example illumination apparatus 300 (hereinafter may also be referred to as “an illumination apparatus 300”), in accordance with an embodiment of the present disclosure. The illumination apparatus 300 includes optical elements configured to influence propagation of different portions of the first optical distribution 118 emitted by the light source 108.

Similar to the configuration described with reference to FIG. 2, the illumination apparatus 300 includes the light source 108 configured to emit light rays about the optical axis 110 within the first hemisphere to form the first optical distribution 118. The first optical distribution 118 may be substantially rotationally symmetrical about the optical axis 110.

As previously described, the first optical distribution 118 includes the first zone 112, the second zone 114, and the third zone 116. The first zone 112 corresponds to light rays emitted at relatively larger angles relative to the optical axis 110, the second zone 114 corresponds to light rays emitted at intermediate angles relative to the optical axis 110, and the third zone 116 corresponds to light rays emitted at smaller angles relative to the optical axis 110.

In the illustrated embodiment, the illumination apparatus 300 further includes an uplight optic 310 positioned relative to the light source 108 so as to receive at least a portion 302 of the first zone 112 of the first optical distribution 118. The uplight optic 310 is adapted to redirect the received portion 302 of the first zone 112 into a second hemisphere opposite the first hemisphere to form an uplight distribution 308.

The uplight optic 310 may include a reflective surface adapted to reflect the received portion 302 of the first zone 112. In various embodiments, the reflective mechanism may include reflection from a metallic mirror, a dielectric mirror, or total internal reflection generated by prismatic structures formed in the uplight optic 310. Through this interaction, a majority of the light corresponding to the received portion 302 of the first zone 112 may be redirected toward the second hemisphere.

The illumination apparatus 300 further includes a wedge optic 320 positioned relative to the light source 108 so as to intercept at least a portion 304 of the second zone 114 of the first optical distribution 118. The wedge optic 320 is configured to transmit and refract the intercepted portion 304 such that refracted light rays 312 exit the wedge optic 320 at an angle relative to the optical axis 110 greater than an entrance angle of the intercepted portion 304 relative to the optical axis 110.

As a result of this refraction, the refracted light rays 312 form a refracted zone distributed at angles wider than the original second zone 114 relative to the optical axis 110. The wedge optic 320 therefore modifies the angular propagation direction of the intercepted portion of the second zone 114 within the first hemisphere.

The third zone 116, which corresponds to light rays emitted closer to the optical axis 110, propagates within the first hemisphere without interaction with the uplight optic 310 or the wedge optic 320. Consequently, the third zone 116 remains unaltered by the optical elements illustrated in FIG. 3.

Through the combined interaction of the uplight optic 310 and the wedge optic 320, the illumination apparatus 300 produces a structured optical distribution in which different portions of the emitted light are directed toward different angular regions. In particular, portions of the first zone 112 may be redirected toward the second hemisphere by the uplight optic 310, portions of the second zone 114 may be refracted to larger propagation angles within the first hemisphere by the wedge optic 320, and portions of the third zone 116 may propagate unaffected along directions closer to the optical axis 110.

The resulting overall optical distribution may therefore include a combination of the uplight distribution generated by the uplight optic 310, the refracted zone generated by the wedge optic 320, and the portion of the first optical distribution corresponding to the third zone 116.

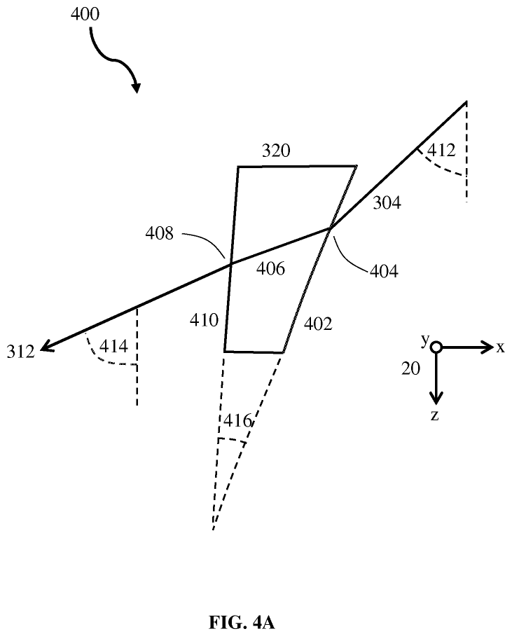

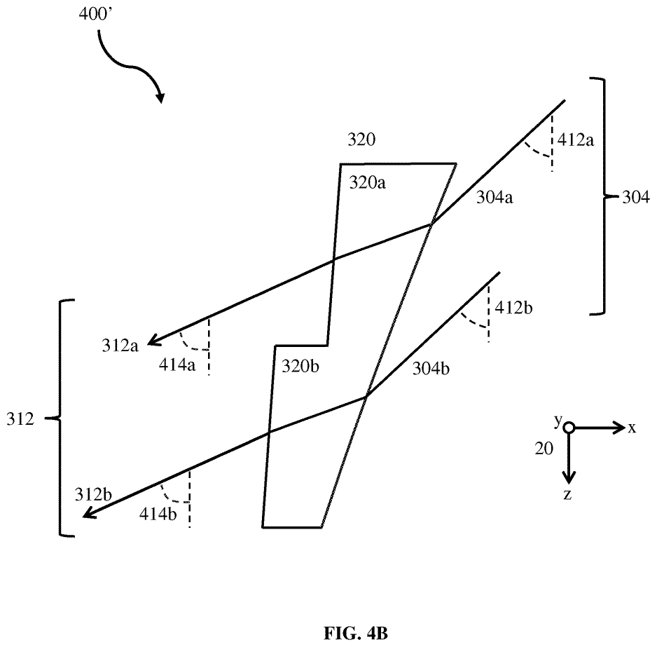

FIG. 4A illustrates a schematic representation 400 showing optical interaction of light rays with the wedge optic 320 of the illumination apparatus 300 described with reference to FIG. 3, in accordance with an embodiment of the present disclosure.

As described with reference to FIGS. 2 and 3, the light source 108 emits light rays forming the first optical distribution 118 within the first hemisphere centered about the optical axis 110. The first optical distribution 118 includes the first zone 112, the second zone 114, and the third zone 116 defined according to their respective angles relative to the optical axis 110.

In the illustrated embodiment, a portion of the second zone 114 propagates toward the wedge optic 320. The wedge optic 320 is positioned relative to the light source 108 such that the portion 304 of the second zone 114 is intercepted by the wedge optic.

The wedge optic 320 includes a first surface 402 and a second surface 410 arranged to form a wedge-shaped refractive structure. The first surface 402 functions as an incident surface configured to receive the portion 304 of the second zone 114 entering the wedge optic 320.

The portion 304 of the second zone 114 enters the wedge optic 320 through the first surface 402 at an entrance angle 412 relative to the optical axis 110. Upon entering the wedge optic 320, the light rays propagate within the optically transmissive material of the wedge optic 320.

Due to an angle 416 between the first surface 402 and the second surface 410, the propagation direction of the light rays is modified by refraction as the light rays travel through the wedge optic 320.

The light rays subsequently exit the wedge optic 320 through the second surface 410 as the refracted light rays 312. The refracted light rays 312 exit the wedge optic at an exit angle 414 relative to the optical axis 110 that is greater than the entrance angle 412 of the intercepted portion 304 relative to the optical axis 110.

Through this refraction process, the wedge optic 320 redirects the intercepted portion 304 of the second zone 114 such that the refracted light rays 312 form a refracted zone distributed at angles wider than the second zone 114 relative to the optical axis 110.

In various embodiments, the wedge optic 320 may be formed from an optically transmissive material including polymethyl methacrylate (PMMA), polycarbonate, silicone, glass, or other optical materials capable of transmitting and refracting visible light.

FIG. 4B illustrates a schematic representation 400′ showing optical interaction of light rays with an alternate configuration of the wedge optic 320, in accordance with an embodiment of the present disclosure.

In the illustrated embodiment, the wedge optic 320 comprises a plurality of wedge structures in vertical succession along the optical axis 110 of the illumination apparatus 300. In particular, the wedge optic 320 may include a first wedge structure 320a and a second wedge structure 320b positioned one over the other such that different portions of the intercepted portion 304 of the second zone 114 interact with the respective wedge structures.

The portion 304 of the second zone 114 propagates toward the wedge optic 320 and may be divided into corresponding sub-portions as the light interacts with the plurality of wedge structures. In the illustrated embodiment, a first sub-portion 304a of the second zone 114 interacts with the first wedge structure 320a and a second sub-portion 304b of the second zone 114 interacts with the second wedge structure 320b.

Each of the wedge structures 320a and 320b may include respective incident and exit surfaces arranged to form wedge-shaped refractive structures similar to the configuration described with reference to FIG. 4A. As the light rays propagate through the respective wedge structures, the light rays undergo refraction and exit the wedge optic as the refracted light rays 312a, 312b.

Due to the wedge-shaped geometry of the plurality of wedge structures, the refracted light rays 312a, 312b exit the wedge optic 320 at angles 414a, 414b relative to the optical axis 110 that are greater than the entrance angles 412a, 412b of the sub-portions 304a, 304b of the intercepted portion 304 relative to the optical axis 110.

Through this configuration, the plurality of wedge structures 320a and 320b cooperate to redirect portions of the second zone 114 to form a refracted zone distributed at angles wider than the second zone relative to the optical axis 110.

In various embodiments, the plurality of wedge structures forming the wedge optic 320 may be arranged circumferentially, linearly, or in other arrangements relative to the optical axis 110 depending on desired optical distribution characteristics.

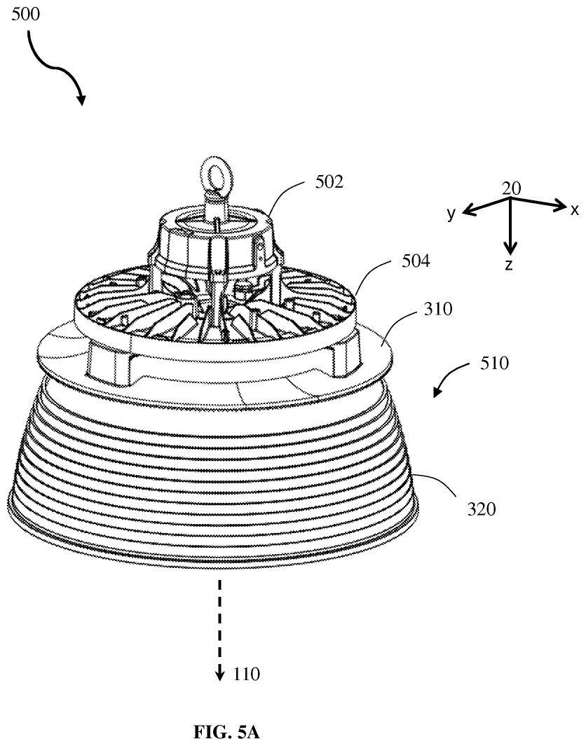

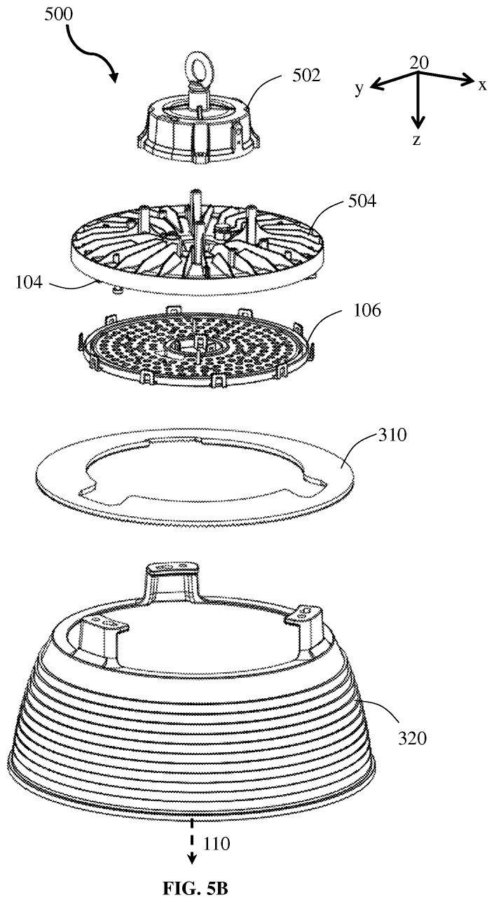

FIG. 5A illustrates a perspective view of an assembled luminaire 500 incorporating the illumination apparatus described herein, in accordance with an embodiment of the present disclosure.

The luminaire 500 includes an electronic driver 502 (hereinafter may also be referred to as “a driver 502”) adapted to provide electrical power to a light emitter disposed within the luminaire 500. The electronic driver 502 may include driver circuitry configured to regulate electrical power supplied to the light emitter during operation of the luminaire.

The luminaire 500 further includes a heatsink 504 thermally coupled to the light emitter 104. The heatsink 504 may include fins or thermally conductive structures adapted to dissipate heat generated by the light emitter during operation of the luminaire.

Disposed below the heatsink 504 is a refractor 510 forming an outer optical structure of the luminaire 500. The refractor 510 may include optical surfaces adapted to influence propagation of light emitted from the light emitter. In certain embodiments, the refractor 510 may include or support the wedge optic 320 described previously with reference to FIGS. 3-4. Here the wedge optic geometry is substantially rotationally symmetric around the optical axis 110 of the luminaire 500.

During operation, the light emitter 104 emits light forming the first optical distribution 118 about the optical axis 110. As previously described, the first optical distribution 118 may include a plurality of angular regions including the first zone, second zone, and third zone.

The luminaire 500 may further include the uplight optic 310 positioned relative to the light emitter 104 such that at least a portion of the first zone of the first optical distribution is intercepted and redirected towards the second hemisphere opposite the first hemisphere. The uplight optic 310 may therefore generate the uplight distribution propagating away from the luminaire in a direction opposite the primary illumination direction.

In addition, the wedge optic 320 associated with the refractor 510 may intercept at least a portion of the second zone of the first optical distribution and refract the intercepted portion to produce refracted light rays distributed at angles greater than those of the second zone relative to the optical axis 110.

Through the combined interaction of the uplight optic 310 and the wedge optic 320, the luminaire 500 may produce a structured optical distribution including light directed into the second hemisphere and light refracted to wider angles within the first hemisphere.

FIG. 5B illustrates an exploded view of the luminaire 500 shown in FIG. 5A, in accordance with an embodiment of the present disclosure.

As illustrated in FIG. 5B, the luminaire 500 includes the electronic driver 502 positioned above the heatsink 504. The heatsink 504 may be thermally coupled to the light emitter 104 in order to dissipate heat generated during operation of the light emitter.

The luminaire 500 further includes the optic 106 disposed adjacent to the light emitter 104. The optic 106 may be configured to influence an initial optical distribution of light emitted from the light emitter and may contribute to formation of the first optical distribution 118 propagating along the optical axis 110.

The optical axis 110 may correspond to a central axis of symmetry of the luminaire 500 and may define the center of the first hemisphere within which the primary portion of the first optical distribution propagates. The second hemisphere may be defined in a direction opposite the first hemisphere relative to the optical axis.

The luminaire 500 further includes the refractor 510 disposed below the optical components of the luminaire. The refractor 510 may form an outer optical enclosure and may include optical features configured to influence propagation of light emitted from the light emitter.

In certain embodiments, the refractor 510 may include the wedge optic 320 adapted to refract a portion of the emitted light distribution as described previously. The luminaire 500 may also include the uplight optic 310 positioned to intercept a portion of the emitted light and redirect the intercepted portion into the second hemisphere. As shown in FIGS. 5A and 5B, the wedge optic 320 and the uplight optic 310 are substantially rotationally symmetric around the optical axis 110 of the luminaire 500.

When assembled, the components illustrated in FIG. 5B form the luminaire 500 shown in FIG. 5A, which produces an overall optical distribution that is generally rotationally symmetrical about the optical axis 110.

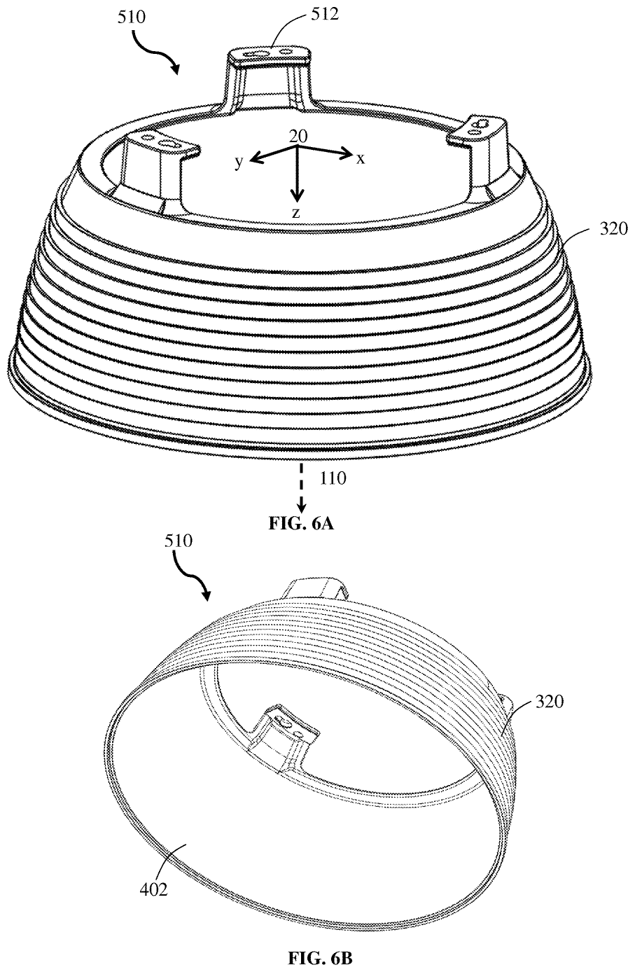

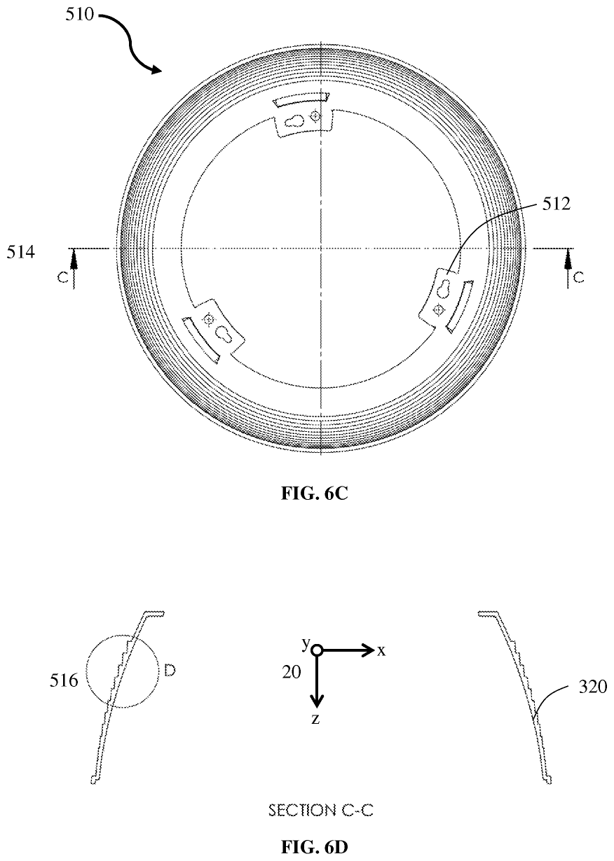

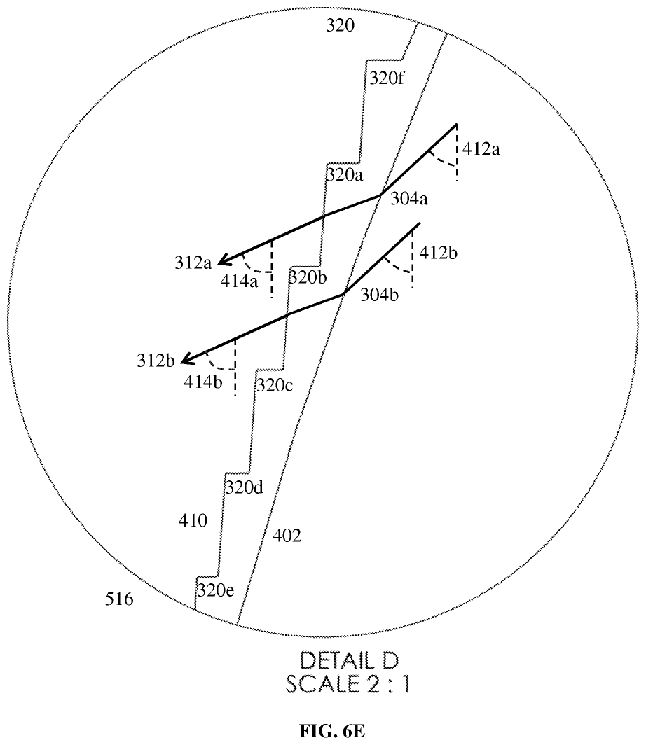

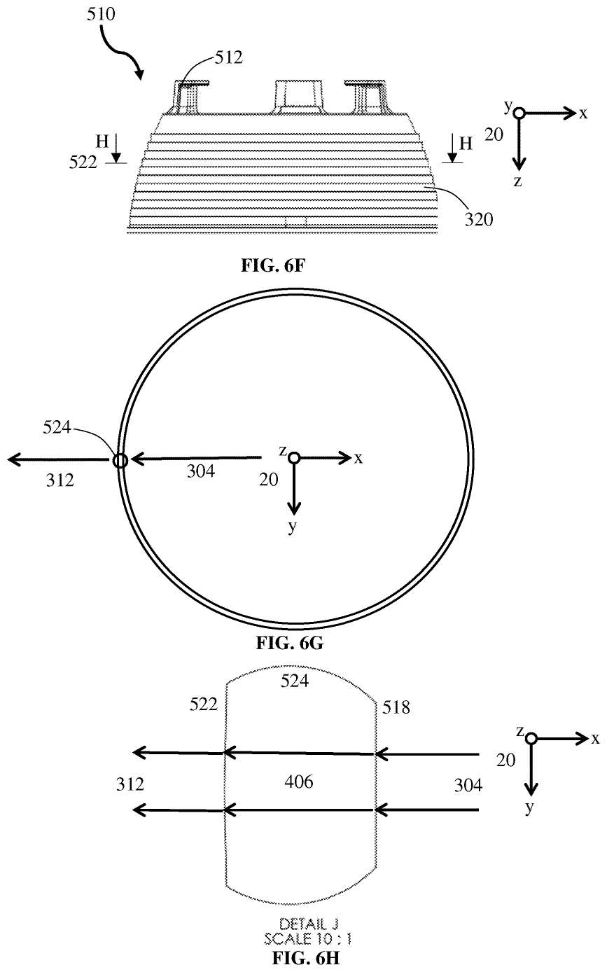

FIG. 6A illustrates a perspective view of the refractor 510 of the luminaire 500 of FIG. 5A, in accordance with an embodiment of the present disclosure.

The refractor 510 may form an outer optical structure of the luminaire 500 and may be adapted to receive light emitted from the light emitter positioned within the luminaire assembly. The refractor 510 may be formed from an optically transmissive material such as glass, polymethyl methacrylate (PMMA), polycarbonate, silicone, or other suitable optical materials capable of transmitting visible light.

As illustrated in FIG. 6A, the refractor 510 includes a body portion having a generally circular geometry centered about the optical axis 110. The refractor 510 may therefore exhibit rotational symmetry about the optical axis 110 such that optical interaction of light within the refractor may be substantially uniform around the circumference of the refractor 510.

The refractor 510 further includes a plurality of support legs 512 extending from an upper portion of the refractor. The support legs 512 may be configured to mechanically couple the refractor 510 to other structural components of the luminaire 500, such as the heatsink or a mounting structure within the luminaire assembly.

In certain embodiments, the refractor 510 may include or integrally form the wedge optic 320 described previously with reference to FIGS. 3-4. The wedge optic 320 may therefore extend circumferentially around the optical axis 110 such that the wedge optic 320 is substantially circularly symmetric relative to the optical axis 110.

Through this circular symmetric configuration, the wedge optic 320 may intercept portions of the second zone of the first optical distribution emitted from the light source and refract the intercepted light to form refracted light rays distributed at wider angles relative to the optical axis 110.

In various embodiments, the refractor 510 may further include additional optical surface features configured to influence propagation of light transmitted through the refractor, including refractive surfaces, prismatic structures, or diffusing features formed on interior or exterior surfaces of the refractor.

FIG. 6B illustrates another perspective view of the refractor 510 of the luminaire 500 of FIG. 5A, in accordance with an embodiment of the present disclosure. In the illustrated orientation, the refractor 510 is rotated relative to the view shown in FIG. 6A such that an interior region of the refractor becomes visible.

The interior surface of the refractor 510 corresponds to an incident surface 402 of the wedge optic 320. The incident surface 402 is configured to receive a portion of the first optical distribution 118 emitted by the light source positioned within the luminaire assembly.

In particular, a portion of the second zone 114 of the first optical distribution 118 may propagate toward the incident surface 402, where the light rays initially interact with the wedge optic 320. The wedge optic 320 may extend circumferentially around the optical axis 110 such that the optical structure may exhibit rotational symmetry about the optical axis 110.

The configuration illustrated in FIG. 6B therefore demonstrates how the refractor 510 may incorporate the wedge optic 320 so that the interior surface of the refractor 510 functions as the incident optical surface that receives and redirects portions of the optical distribution emitted by the light source.

FIG. 6C illustrates a top view of the refractor 510, in accordance with an embodiment of the present disclosure. In this view, the refractor is observed in X-Y plane and along a direction substantially parallel to the optical axis 110.

The refractor 510 has a circular configuration centred about the optical axis 110, thereby providing rotational symmetry around the optical axis 110. This geometry enables optical interaction of light within the refractor 510 to occur substantially uniformly around the circumference of the refractor.

The refractor 510 further includes the support legs 512 arranged around an inner region of the refractor. The support legs may be configured to mechanically couple the refractor to other components of the luminaire assembly.

An outer annular region of the refractor includes a plurality of circumferential optical surface features forming part of the wedge optic 320. A section line C-C 514 is illustrated across the refractor. The section line indicates the location at which a cross-sectional view of the refractor is taken.

FIG. 6D illustrates a cross-sectional view of the refractor 510 taken along the section line C-C 514 of FIG. 6C, in accordance with an embodiment of the present disclosure. The cross-section is shown in an X-Z plane relative to the coordinate system 20.

The cross-sectional geometry reveals a curved wall structure of the refractor that forms part of the wedge optic 320. The interior surface corresponds to the incident surface 402 of the wedge optic.

The outer region of the refractor wall includes a plurality of stepped or faceted optical surface features that form stacked wedge segments of the wedge optic 320. These wedge structures are configured to intercept light propagating from the light source and modify the propagation direction of the light rays through refraction within the refractor material.

FIG. 6E illustrates an enlarged view D 516 of the cross-section shown in FIG. 6D, in accordance with an embodiment of the present disclosure. The enlarged view reveals structural and optical features of the wedge optic 320 in greater detail.

The wedge optic 320 includes a plurality of wedge segments arranged sequentially along the refractor wall. In the illustrated embodiment the wedge segments include segments 320a, 320b, 320c, 320d, 320e, and 320f. Each wedge segment includes the incident surface 402 and a corresponding exit surface 410 arranged to form a wedge-shaped refractive structure. Light rays such as intercepted rays 304a and 304b may be incident on the incident surface 402 at entrance angles 412a and 412b relative to the optical axis. After propagating through the refractive material of the wedge optic segments 320a, 320b, the light rays exit through the exit surface 410 to form refracted rays 312a and 312b.

The refracted rays may propagate at exit angles 414a and 414b relative to the optical axis 110 that are greater than the corresponding entrance angles 412a and 412b relative to the optical axis 110. Accordingly, the wedge segments collectively redirect portions 304a, 304b of the optical distribution so that the refracted light rays 312a, 312b are distributed at wider angles 414a, 414b relative to the optical axis 110.

FIG. 4B previously illustrated a simplified optical interaction involving two wedge segments, such as segments 320a and 320b, while FIG. 6E illustrates a more detailed structure including multiple wedge segments arranged sequentially.

FIG. 6F illustrates a side view of the refractor 510, in accordance with an embodiment of the present disclosure. The refractor 510 is viewed in an X-Z plane depicting the overall profile of the refractor and the wedge optic structure.

A section line H-H 522 is illustrated in FIG. 6F. The section line defines the location along which an additional cross-sectional view of the refractor is obtained.

FIG. 6G illustrates a cross-sectional view of the refractor 510 taken along the section line H-H 522 of FIG. 6F, in accordance with an embodiment of the present disclosure. The cross-section is illustrated in an X-Y plane relative to coordinate system 20.

The cross-sectional view reveals the orientation of the incident surface 402 and the exit surface 410 of the wedge optic around the circumference of the refractor. Incident rays 304 may propagate toward the incident surface 402 and travel through the wedge optic before exiting through the exit surface 410 as refracted rays 312.

FIG. 6H illustrates an enlarged detail view corresponding to a portion of the cross-section shown in FIG. 6G, in accordance with an embodiment of the present disclosure.

The enlarged view reveals local surface geometry of the wedge optic surfaces. In the illustrated configuration, the incident surface 402 and the exit surface 410 may be arranged such that the surfaces are substantially parallel in the depicted cross-section. As a result, light rays entering the wedge optic may exit the refractor with a propagation direction that remains substantially parallel to the direction of the incident rays.

The incident surface and exit surface may be separated by a local thickness 406 of the refractor wall. The local geometry of these surfaces may include curved, planar, or faceted regions depending on the desired optical design.

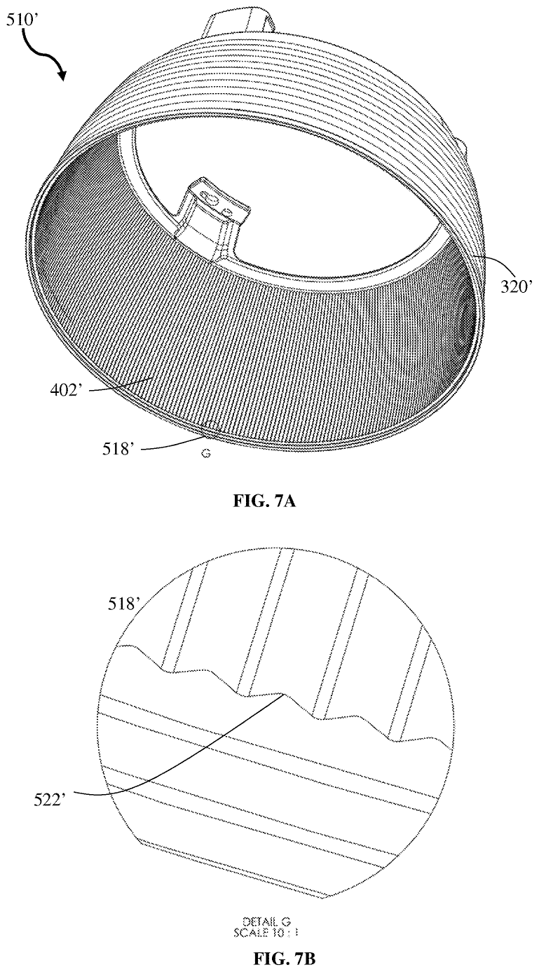

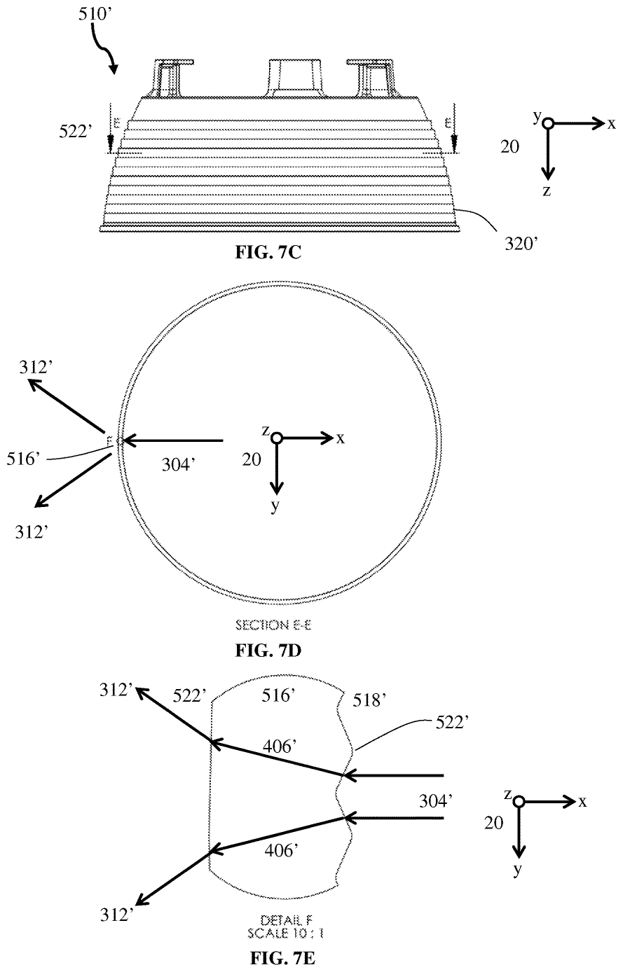

FIG. 7A illustrates a perspective view of an alternate embodiment of a refractor 510′ incorporating an alternate wedge optic 320′, in accordance with an embodiment of the present disclosure.

The refractor 510′ may be generally similar in overall configuration to the refractor described previously but may include modified optical surface features configured to influence the propagation of light rays within the refractor. The refractor 510′ may be formed from an optically transmissive material such as glass, polymethyl methacrylate (PMMA), polycarbonate, silicone, or other suitable optical materials.

As illustrated in FIG. 7A, the refractor 510′ includes a circumferential optical region that forms the wedge optic 320′. The wedge optic 320′ may extend around the optical axis of the luminaire and may be configured to intercept portions of the optical distribution emitted by the light source.

An interior surface region of the wedge optic 320′ includes an incident surface 518′ that may receive refractor incident rays emitted by the light source within the luminaire assembly. In the illustrated embodiment, an incident surface 402′ of the wedge optic 320′ includes a plurality of linear grooves extending along the interior surface of the refractor.

The linear grooves may be arranged substantially parallel to one another and may form prismatic optical structures configured to modify propagation of light rays interacting with the wedge optic 320′. Through interaction with these grooves, incident light rays may be refracted or redirected to influence the spatial distribution of light emitted from the luminaire.

A region indicated as detail G referenced by 518′ corresponds to a localized portion of the incident surface 402′ and is shown in greater detail in FIG. 7B.

The refractor 510′ includes linear grooves 522′ formed as elongated prismatic structures arranged substantially parallel to one another along the interior surface 402′ of the refractor 510′. These grooves may be configured to modify the direction of light rays propagating through the refractor by refraction or controlled redirection.

FIG. 7B illustrates an enlarged view of a surface region of the refractor 510′ of FIG. 7A, in accordance with an embodiment of the present disclosure. The enlarged view corresponds to the region indicated as detail G in FIG. 7A.

As illustrated in FIG. 7B, the surface region 518′ includes a plurality of linear grooves 522′ formed along the interior optical surface 402′ of the refractor 510′. The grooves extend generally in a longitudinal direction and are arranged substantially parallel to one another across the surface region.

The linear grooves may form prismatic optical structures configured to interact with light rays propagating within the refractor. Each groove may include sloped or faceted sidewalls that influence the propagation direction of light rays interacting with the grooved surface.

In operation, light rays propagating within the refractor may first interact with the incident surface 402′ of the wedge optic and enter the refractor material. The rays may subsequently interact with the grooved surface region 518′ where the geometry of the grooves may cause lateral deflection or redistribution of the light rays.

The cross-sectional profile of the grooves in the surface region 518′ may be prismatic, curved, faceted, or otherwise shaped depending on the desired optical performance. Through appropriate selection of groove geometry, the refractor may modify the angular distribution of light propagating through the wedge optic.

The grooved surface region 518′ may therefore function as an optical surface that modifies propagation of light within the refractor before the light rays exit the refractor through an exit surface of the wedge optic.

FIG. 7C illustrates a side view of the refractor 510′, in accordance with an embodiment of the present disclosure. The view shows the overall profile of the refractor in an X-Z plane and the arrangement of the optical surfaces forming the alternate wedge optic structure.

A section line E-E 522′ is indicated in FIG. 7C. The section line identifies the location along which a cross-sectional view of the refractor is obtained in order to illustrate optical interaction of light rays with the grooved surface structures.

FIG. 7D illustrates a cross-sectional view of the refractor 510′ taken along the section line E-E 522′ of FIG. 7C, in accordance with an embodiment of the present disclosure. The cross-section is shown in an X-Y plane relative to the coordinate system 20.

In this orientation, refractor incident rays 304′ may propagate toward the interior surface of the refractor where the linear grooves 522′ are located. The grooves may interact with the incident rays and redirect the rays within the refractor material.

In particular, the linear grooves may cause a lateral deflection of the refractor incident rays 304′ such that the rays are redirected into refracted rays 406′ within the wedge optic structure.

The refracted rays 406′ may subsequently interact with an exit surface of the refractor, where additional refraction may occur. After exiting the refractor, the light rays may form refracted zone rays 312′ that propagate within the surrounding environment. As illustrated in FIG. 7D, the refracted rays 312′ may be redirected into an orientation that is not parallel to the original refractor incident rays 304′. This lateral deviation enables redistribution of light within the first hemisphere.

FIG. 7E illustrates an enlarged detail view E 516′ corresponding to a portion of the refractor surface shown in FIG. 7D, in accordance with an embodiment of the present disclosure. The enlarged view reveals local surface geometry of the grooved optical surface in greater detail.

The incident surface of the refractor may include prismatic, curved, faceted, or other geometrical profiles configured to modify propagation of incident light rays. The specific geometry of the grooves may be selected to achieve a desired lateral deviation or redistribution of light within the refractor.

In certain embodiments, the exit surface 522′ may also include linear grooved features or other surface structures that further influence propagation of light rays exiting the refractor.

In certain embodiments, a majority of the light rays incident on the wedge optic portion of the refractor 510 or the alternate refractor 510′ may be transmitted through the refractor material, while only a minority portion of the optical energy may be reflected.

Accordingly, the refractor 510 or 510′ may primarily function as a refractive optical element rather than a reflective optical component.

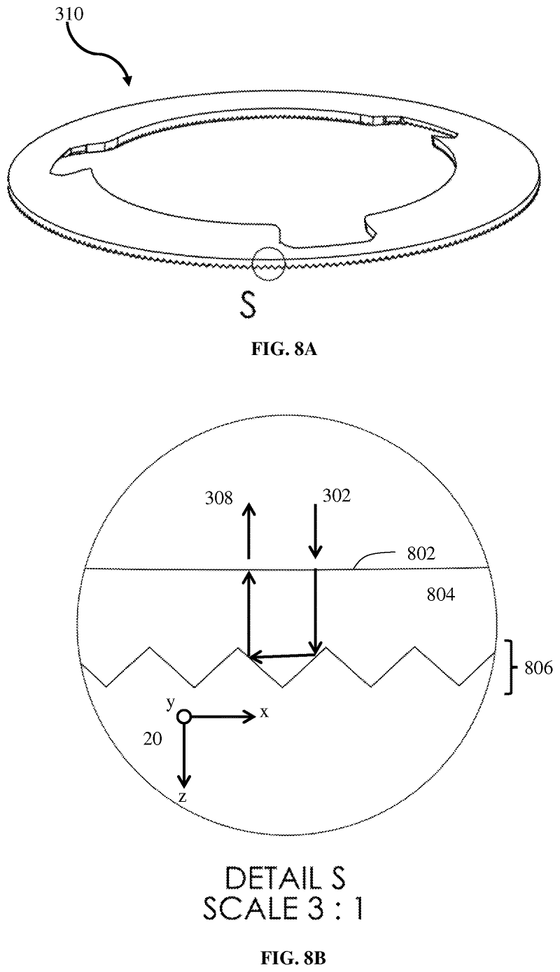

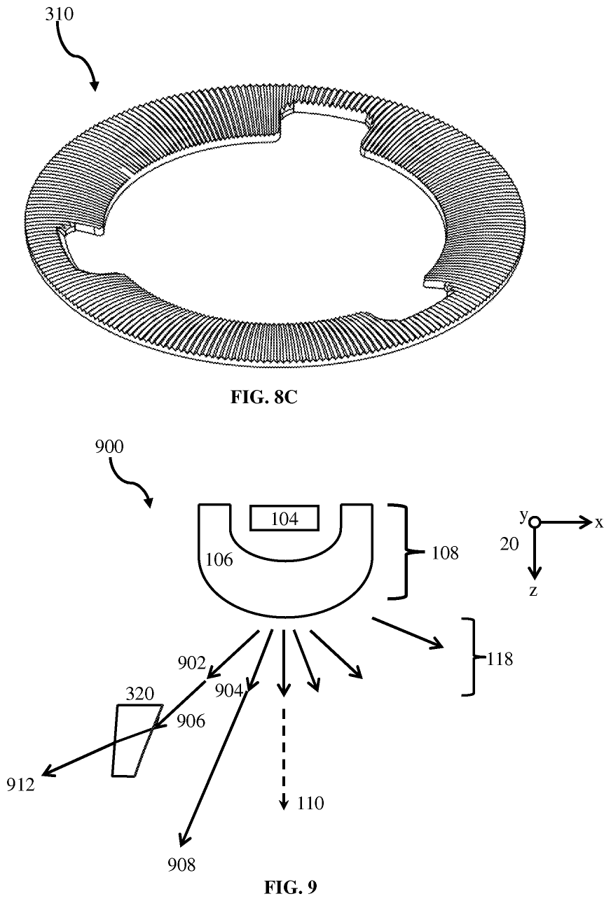

FIGS. 8A through 8C illustrates various views of an uplight optic 310, in accordance with an embodiment of the present disclosure. The uplight optic 310 is adapted to redirect a portion of light emitted by the illumination apparatus into an uplight zone. The uplight optic 310 may be formed from an optically transmissive material such as polymethyl methacrylate (PMMA), polycarbonate, glass, or another optical-grade transmissive material suitable for molding or fabrication of optical structures.

FIG. 8A illustrates a perspective view of the uplight optic 310. In the illustrated embodiment, the uplight optic 310 includes a generally annular body configured to be positioned within the illumination apparatus so as to intercept a portion of light emitted from the light source. The annular body defines an inner opening that allows passage of other optical components or structural elements of the luminaire.

A circumferential outer region of the uplight optic 310 includes a plurality of prism structures distributed around the perimeter of the optic. These prism structures are arranged sequentially along the circumference of the optic and collectively form an optical surface configured to redirect incident light. The prism structures may extend continuously or substantially continuously around the outer edge of the optic.

FIG. 8B illustrates an enlarged view of detail S of the uplight optic 310. The enlarged view corresponds to a cross-sectional region of the optic taken along a plane substantially parallel to the X-Z plane of the coordinate system 20.

As illustrated in FIG. 8B, uplight incident zone rays 302 propagate toward the uplight optic and interact with an incident surface 802 of the optic. The incident surface 802 defines an entry interface through which the incident rays are transmitted into the interior of the uplight optic material.

After entering the uplight optic, the transmitted rays propagate within the optic material 804 and interact with prism structures 806 formed within the optic. The prism structures 806 may be configured with geometries that cause the internally propagating rays to undergo total internal reflection (TIR).

Through the TIR interaction with the prism structures 806, the direction of propagation of the rays is redirected such that the rays are reflected back toward the incident surface 802. The redirected rays subsequently exit the optic through the incident surface 802 and propagate outward to form the uplight zone 308.

The geometry of the prism structures 806 may be selected to control the angular distribution of the uplight rays forming the uplight zone 308. In some embodiments, the prism structures may have triangular, faceted, curved, or otherwise shaped profiles designed to promote efficient total internal reflection and desired uplight distribution characteristics.

FIG. 8C illustrates another perspective view of the uplight optic 310, revealing the circumferential distribution of the prism structures along the outer region of the optic. As shown, the prism structures form a series of closely spaced optical features extending around the circumference of the optic.

The circumferential arrangement of the prism structures allows the uplight optic 310 to redirect light uniformly around the optical axis of the illumination apparatus. In this manner, the uplight optic 310 may generate an uplight optical distribution that is substantially rotationally symmetric about the optical axis.

In operation, the uplight optic 310 therefore receives a portion of the emitted light as uplight incident zone rays and redirects the light through total internal reflection to produce the uplight zone above the illumination apparatus while allowing other portions of emitted light to propagate toward other optical components of the luminaire.

FIG. 9 illustrates a schematic representation of an illumination apparatus 900, in accordance with an embodiment of the present disclosure. The schematic diagram illustrates an example distribution of light emitted from a light source and the interaction of a portion of the emitted light with a wedge optic.

The illumination apparatus 900 includes at least one light source 108 configured to emit light rays about an optical axis 110. The emitted light forms a first optical distribution 118 within a first hemisphere relative to the optical axis 110. In some embodiments, the first optical distribution 118 may be substantially rotationally symmetrical about the optical axis.

As illustrated in FIG. 9, the first optical distribution 118 may include multiple angular regions defined by different sets of emitted rays. In particular, the first optical distribution may include a first zone 902 and a second zone 904.

The first zone 902 may be defined by a first set of emitted light rays that propagate from the light source at relatively larger angular offsets from the optical axis 110. The second zone 904 may be defined by a second set of emitted light rays that propagate at comparatively smaller angular offsets relative to the optical axis.

In the illustrated embodiment, the first zone 902 therefore corresponds to rays emitted at angles greater than the rays forming the second zone 904 relative to the optical axis 110.

A wedge optic 320 may be positioned within the optical path of at least a portion of the first zone 902. The wedge optic is configured to intercept a portion 906 of the first zone rays propagating within the first optical distribution.

Upon entering the wedge optic 320, the intercepted portion 906 of the first zone rays is transmitted through the wedge optic material and refracted by optical surfaces of the wedge optic. The wedge optic may include incident and exit refractive surfaces configured to alter the propagation direction of the intercepted rays.

As a result of this refraction, the intercepted rays exit the wedge optic as refracted rays 912. The refracted rays propagate at angles relative to the optical axis 110 that are greater than the entrance angles of the corresponding intercepted rays.

The refracted rays 912 therefore form a refracted zone within the first hemisphere, the refracted zone being distributed at angular positions wider than the angular region corresponding to the original first zone 902.

In contrast, the second zone 904 of the first optical distribution may propagate through the illumination apparatus without angular redirection by the wedge optic 320. Accordingly, the second zone rays may continue propagating within the first hemisphere substantially along their original emission directions relative to the optical axis.

Through this arrangement, the wedge optic 320 selectively modifies a portion of the emitted optical distribution by increasing the angular spread of selected rays while allowing other portions of the emitted light distribution to propagate substantially unmodified.

It is contemplated that any of the foregoing aspects, and/or various separate aspects and features as described herein, may be combined for additional advantage. Any of the various embodiments as disclosed herein may be combined with one or more other disclosed embodiments unless indicated to the contrary herein.

Those skilled in the art will recognize improvements and modifications to the preferred embodiments of the present disclosure. All such improvements and modifications are considered within the scope of the concepts disclosed herein and the claims that follow.

While various embodiments of the present invention have been described above, it should be understood that they have been presented by way of example, and not limitation. It will be apparent to one skilled in the relevant art(s) that various changes in form and detail can be made therein without departing from the spirit and scope of the invention. Thus, the present invention should not be limited by any of the above-described exemplary embodiments but should be defined only in accordance with the following claims and their equivalents.

It is to be understood that, if any prior art publication is referred to herein, such reference does not constitute an admission that the publication forms a part of the common general knowledge in the art, in Australia or any other country.

It will be understood to persons skilled in the art of the invention that many modifications may be made without departing from the spirit and scope of the invention.

What is claimed is:

1. An illumination apparatus, comprising:
a housing;
at least one light source mounted on the housing and adapted to emit light into a first hemisphere centered about an optical axis forming a first optical distribution, the optical axis being oriented in a downward direction;
a refractor element having a body portion surrounding the at least one light source and extending about the optical axis, the body portion defining a bottom opening; and
a bottom lens disposed across at least a portion of the bottom opening to substantially enclose the bottom opening,
wherein
the bottom lens includes a central portion having an inward protruding profile extending towards the at least one light source,
at least a first portion of the first optical distribution is transmitted through the bottom lens into the first hemisphere, and at least a second portion of the first optical distribution is reflected by the bottom lens to form a second optical distribution directed in an upward direction into a second hemisphere opposite the first hemisphere.

2. The illumination apparatus of claim 1, wherein the at least one light source comprises at least one of
a light emitting diode (LED); or
the LED and an optic positioned adjacent to the LED, the optic adapted to intercept and redirect at least a portion of the emitted light forming the first optical distribution.

3. The illumination apparatus of claim 1, wherein the bottom lens includes a plurality of elongated features extending radially from the central portion of the bottom lens towards a peripheral region of the body portion of the refractor element.

4. The illumination apparatus of claim 3, wherein the plurality of elongated features is provided on an interior surface of the bottom lens.

5. The illumination apparatus of claim 4, wherein the plurality of elongated features comprises one or more of grooves, ridges, prisms, flutes, or refractive structures adapted to redistribute the first optical distribution incident on the bottom lens.

6. The illumination apparatus of claim 1, wherein the inward protruding profile of the central portion has a protrusion height (h), measured along the optical axis from a peripheral plane of the bottom lens, of at least 10 mm, 20 mm, 40 mm, 60 mm, or 80 mm.

7. The illumination apparatus of claim 1, wherein a ratio (hₘₐₓ/w) of a maximum protrusion height (h) to a lateral width (w) of the bottom lens is at least 0.10, 0.20, 0.30, 0.40 or 0.50.

8. The illumination apparatus of claim 1, wherein the bottom lens is formed of an optically transmissive material including at least one of diffusion particles, scattering additives, surface roughness, or combinations thereof to cause scattering of the first optical distribution incident on the bottom lens.

9. The illumination apparatus of claim 1, wherein the refractor element comprises at least one wedge optic formed on or integrated with the body portion of the refractor element.

10. The illumination apparatus of claim 1, wherein a ratio of a total luminous flux emitted by the illumination apparatus with the bottom lens to a total luminous flux emitted in absence of the bottom lens is at least 0.90, 0.95, or 0.98.

11. The illumination apparatus of claim 1, wherein majority of the second portion of the first optical distribution incident on the inward protruding profile are reflected towards the refractor element and away from the housing and the at least one light source.

12. An illumination apparatus, comprising:
a housing;
at least one light source mounted on the housing and adapted to emit light into a first hemisphere centered about an optical axis forming a first optical distribution, the optical axis being oriented in a downward direction;
a refractor element having a body portion surrounding the at least one light source and extending about the optical axis, the body portion defining a bottom opening; and
a bottom lens disposed across at least a portion of the bottom opening to substantially enclose the bottom opening,
wherein
the bottom lens includes a central portion having an inward protruding profile extending towards the at least one light source,
at least a first portion of the first optical distribution is transmitted through the bottom lens into the first hemisphere, and at least a second portion of the first optical distribution is reflected by the bottom lens to form a second optical distribution directed in an upward direction into a second hemisphere opposite the first hemisphere,
a ratio of a total luminous flux emitted by the illumination apparatus with the bottom lens to a total luminous flux emitted in absence of the bottom lens is at least 0.90, 0.95, or 0.98.

13. The illumination apparatus of claim 12, wherein a ratio (hₘₐₓ/w) of a maximum protrusion height (h) to a lateral width (w) of the bottom lens is at least 0.10, 0.20, 0.30, 0.40 or 0.50.

14. An illumination apparatus, comprising:
a housing;
at least one light source mounted on the housing and adapted to emit light into a first hemisphere centered about an optical axis forming a first optical distribution, the optical axis being oriented in a downward direction;
a refractor element having a body portion surrounding the at least one light source and extending about the optical axis, the body portion defining a bottom opening; and
a bottom lens disposed across at least a portion of the bottom opening to substantially enclose the bottom opening,
wherein
the bottom lens includes a central portion having an inward protruding profile extending towards the at least one light source,
at least a first portion of the first optical distribution is transmitted through the bottom lens into the first hemisphere, and at least a second portion of the first optical distribution is reflected by the bottom lens to form a second optical distribution directed in an upward direction into a second hemisphere opposite the first hemisphere,
a ratio (hₘₐₓ/w) of a maximum protrusion height (h) to a lateral width (w) of the bottom lens is at least 0.10, 0.20, 0.30, 0.40 or 0.50.

15. The illumination apparatus of claim 14, wherein a ratio of a total luminous flux emitted by the illumination apparatus with the bottom lens to a total luminous flux emitted in absence of the bottom lens is at least 0.90, 0.95, or 0.98.
